(19) United States
(12) Patent Application Publication
(10) Pub. No.: US 2015/0208336 A1
(43) Pub. Date: Jul. 23, 2015

(54) Mobile Terminal, Communication Method, Communication System Program, Information Processing Apparatus, Service Rendering Method and Distribution Server

(71) Applicant: NEC Corporation, Tokyo (JP)

(72) Inventors: Takahiro Iihoshi, Tokyo (JP); Shuichi Karino, Tokyo (JP); Akira Tsuji, Tokyo (JP); Yoshikazu Watanabe, Tokyo (JP); Gen Morita, Tokyo (JP)

(21) Appl. No.: 14/419,220

(22) PCT Filed: Aug. 2, 2013
(86) PCT No.: PCT/JP2013/004686

§ 371 Date: Feb. 2, 2015

(30) Foreign Application Priority Data
Aug. 3, 2012 (JP) 2012-172763

(51) Int. Cl. H04W 48/18

(52) U.S. Cl. CPC H04W 48/18; H04W 88/02

(57) ABSTRACT

A mobile terminal includes: a plurality of communication interfaces that are respectively correlated to at least one of a plurality of radio access schemes; and a communication unit that communicates using at least one of the plurality of communication interfaces. The communication unit communicates using a communication interface correlated to a radio access scheme selected based upon a communication fee corresponding to a communication volume and upon a sort of an application used for communication.

### TECHNICAL FIELD

The present application asserts priority rights based on JP Patent Application No. 2012-172763 filed in Japan on Aug. 3, 2012. The total contents of disclosure of the Patent Application of the senior filing date are to be incorporated herein by reference thereto. The present invention relates to a mobile terminal, a communication method, a communication system, a program, an information processing apparatus, a service rendering method and a distribution server. More specifically, the present invention relates to a mobile terminal, a communication method, a communication system, a program, an information processing apparatus and a distribution server that select a radio access scheme used for communication.

### BACKGROUND

Recently, communication operators are introducing communication volume specific charging systems in order to cope with increase in the communication volume of communication terminals, including mobile phones. The users of the communication terminals pay the communication fee to the communication operator in keeping with a communication volume.

Patent Literature (PTL) 1 discloses a technique to select a communication network with the cheapest communication fee from among a plurality of communication networks used for communication. A data communication apparatus estimates, for each of the communication networks, the communication fee correlated to a scheduled volume of data communication, at the outset, and uses the communication network with the cheapest communication fee due to communication.

Patent Literature 2 discloses a technique which, to reduce the communication fee, selects a radio communication system with the cheapest radio communication fee, such as wireless LAN (Local Area Network) or W-CDMA (Wideband Code Division Multiple Access). In Patent Literature 2, a radio communication apparatus selects the radio communication system as stability in wireless connection as well as the communication speed is taken into account in addition to the communication fee.

Moreover, Non-Patent Literature (NPL) 1 describes management objects (MOs) that can be used by Access Network Discovery and Selection Function (ANDSF) and User Equipment (UE).

### CITATION LIST

### Patent Literature

### [PTL 1]

### JP Patent Kokai Publication No. 2000-244486A

### [PTL 2]

### JP Patent Kokai Publication No. 2009-194823A

### Non-Patent Literature

### [NPL 1]

### 3GPP TS 24.312, “Access Network Discovery and Selection Function (ANDSF) Management Object (MO).”

### SUMMARY

### Technical Problem

The entire disclosures of the above Patent Literatures and Non-Patent Literature are incorporated herein by reference thereto. The following analyses are given by the present invention. With the technique disclosed in Patent Literature 1, it is possible to suppress the communication fee. However, the technique suffers a problem that various other needs of terminal users tend to be compromised. It may be felt that terminal users seek for such other element as stability in wireless connection rather than suppression of the communication fee.

In Patent Literature 2, the radio communication apparatus selects the radio communication system as the apparatus takes account not only of the communication fee but also of elements pertinent to the radio communication system, that is, stability in wireless connection or communication speed. However, the technique disclosed in Patent Literature 2 fails to take account of elements pertinent to services exploited by the user of the radio communication apparatus, and hence is not optimum in responding to specified user needs.

Therefore, there is a need in the art to respond to the specified needs of users of communication terminals as the communication fee is suppressed. It is an object of the present invention to provide a mobile terminal, a communication method, a communication system, a program, an information processing apparatus, a service rendering method and a distribution server that contribute to meet the need.

### Solution to Problem

According to a first aspect of the present invention, there is provided a mobile terminal comprising: a plurality of communication interfaces that are respectively correlated to at least one of a plurality of radio access schemes; and communication means (unit) that communicates using at least one of the plurality of communication interfaces. The communication means (unit) communicates using a communication interface correlated to a radio access scheme selected based upon a communication fee corresponding to a communication volume and upon a sort of an application used for communication.

According to a second aspect of the present invention, there is provided a communication method for a mobile terminal including a plurality of communication interfaces that are respectively correlated to at least one of a plurality of radio access schemes. The communication method comprises: by the mobile terminal, communicating using at least one of the plurality of communication interfaces; and communicating using a communication interface correlated to a radio access scheme selected based upon a communication fee corresponding to a communication volume and upon a sort of an application used for communication.

According to a third aspect of the present invention, there is provided a communication system, comprising: a mobile terminal; and a base station correlated to at least one of a plurality of radio access schemes. The mobile terminal comprises: a plurality of communication interfaces that are respectively correlated to at least one of a plurality of radio access schemes; and communication means (unit) that communicates using at least one of the plurality of communication interfaces. The communication means (unit) communicates using a communication interface correlated to a radio access scheme selected based upon a communication fee corresponding to a communication volume and upon a sort of an application used for communication.

According to a fourth aspect of the present invention, there is provided a program, causing a mobile terminal including a plurality of communication interfaces that are respectively correlated to at least one of a plurality of radio access schemes to execute: communicating using at least one of the plurality of communication interfaces; and communicating using a communication interface correlated to a radio access scheme selected based upon a communication fee corresponding to a communication volume and upon a sort of an application used for communication.

According to a fifth aspect of the present invention, there is provided an information processing apparatus, comprising: means (unit) that manages a communication fee corresponding to a cumulative communication volume of a mobile terminal; means (unit) that generates policy information to select a radio access scheme used by the mobile terminal based upon the communication fee and upon a sort of an application used for communication; and means (unit) that notifies the mobile terminal of the policy information.

According to a sixth aspect of the present invention, there is provided a service rendering method, comprising: managing a communication fee corresponding to a cumulative communication volume of a mobile terminal; generating policy information to select a radio access scheme used by the mobile terminal based upon the communication fee and upon a sort of an application used for communication; and notifying the mobile terminal of the policy information.

According to a seventh aspect of the present invention, there is provided a distribution server, comprising means (unit) that distributes a program to a mobile terminal including a plurality of communication interfaces that are respectively correlated to at least one of a plurality of radio access schemes. The program causes the mobile terminal to execute: communicating using at least one of the plurality of communication interfaces; and communicating by a communication interface correlated to a radio access scheme selected based upon a communication fee corresponding to a communication volume and upon a sort of an application used for communication.

### Advantageous Effects of Invention

A mobile terminal, a communication method, a communication system, a program, an information processing apparatus, a service rendering method and a distribution server of the present invention give rise to an advantage for the user of the communication terminal that, as the communication fee is suppressed, it is possible to respond to more specified user needs.

### BRIEF DESCRIPTION OF DRAWINGS

FIG. 1 is a schematic view showing an example system configuration according to a first exemplary embodiment.

FIG. 2 is a schematic block diagram showing an example configuration of a radio communication terminal.

FIG. 3 is a sequence diagram showing an example operation of the first exemplary embodiment.

FIG. 4 is a block diagram showing an example configuration of a second exemplary embodiment.

FIG. 5 is a graph showing an example operation in deciding on a radio access scheme.

FIG. 6 is a graph showing another example operation in deciding on a radio access scheme.

FIG. 7 is a graph showing a further example operation in deciding on a radio access scheme.

FIG. 8 is a tabulated view showing yet another example operation in deciding on a radio access scheme.

FIG. 9 is a tabulated view showing an example operation of a communication unit.

FIG. 10 is a tabulated view showing an example operation in deciding on a radio access scheme.

FIG. 11 is a schematic view showing an example system configuration of a third exemplary embodiment.

FIG. 12 is a schematic block diagram showing an example configuration of a policy control server.

FIG. 13 is a schematic block diagram showing an example of a relevant technique of a fourth exemplary embodiment.

FIG. 14 is a schematic view showing an example of a relevant technique of the fourth exemplary embodiment.

FIG. 15 is a schematic view showing an example system configuration of the fourth exemplary embodiment.

FIG. 16 is a schematic view showing an example configuration of a radio communication terminal of the fourth exemplary embodiment.

FIG. 17 is a schematic block diagram showing an example configuration of a control server of the fourth exemplary embodiment.

FIG. 18 is a tabulated view showing an example operation of the fourth exemplary embodiment.

FIG. 19 is a block diagram showing an example configuration of a virtual switch of the fourth exemplary embodiment.

FIG. 20 is a sequence diagram showing an example operation of the fourth exemplary embodiment.

FIG. 21 is a schematic view showing an example configuration of a fifth exemplary embodiment.

FIG. 22 is a schematic view showing an example configuration of an ANDSF server of the fifth exemplary embodiment.

FIG. 23 is a schematic view showing an example of the information notified from the ANDSF server.

FIG. 24 is a block diagram showing an example configuration of a radio communication terminal of the fifth exemplary embodiment.

FIG. 25 is a diagrammatic view showing another example of the information notified from the ANDSF server.

FIG. 26 is a diagrammatic view showing yet another example of the information notified from the ANDSF server.

FIG. 27 is a diagrammatic view, with a photo, showing an example operation of a sixth exemplary embodiment.

FIG. 28 is a diagrammatic view, with a photo, showing another example operation of the sixth exemplary embodiment.

FIG. 29 is a diagrammatic view, with a photo, showing yet another example operation of the sixth exemplary embodiment.

FIG. 30 is a schematic block diagram showing an example configuration of a seventh exemplary embodiment.

FIG. 31 is a schematic block diagram showing an example configuration of an eighth exemplary embodiment.

### DESCRIPTION OF EMBODIMENTS

### First Exemplary Embodiment

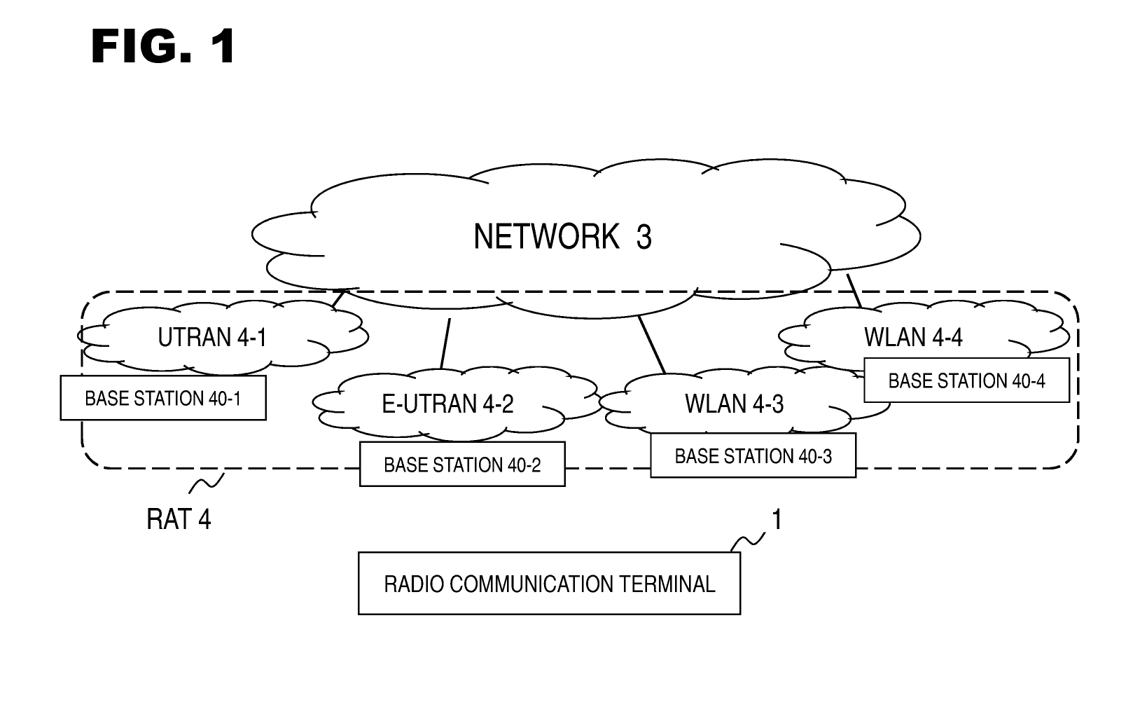

FIG. 1 shows an example configuration of a communication system according to a first exemplary embodiment. A radio communication terminal 1 performs communication with a network 3 over RAT (Radio Access Technology) 4. The RAT may comprise, for example, UTRAN (UMTS (Universal Mobile Telecommunications System) Terrestrial Radio Access Network) 4-1, E-UTRAN (Evolved Universal Terrestrial Radio Access Network) 4-2, and WLANs (Wireless Local Area Networks) 4-3, 4-4. It should be noted that the examples of the RAT 4 shown in FIG. 1 are only by way of illustration, such that the radio communication terminal 1 is able to perform communication with other RAT systems, not shown, for example, WiMAX (Worldwide Interoperability for Microwave Access) and so on.

The radio communication terminal 1 is an apparatus having a communication function, for example, a mobile phone, a personal computer or a mobile router. Note that the mobile router is a terminal that relays between a cellular network and a wireless LAN network, as an example. The mobile phone is connected to the mobile router via e.g., the wireless LAN and to the cellular network via the mobile router.

The radio communication terminal 1 may perform communication in accordance with the radio access scheme (RAT) as selected based upon the communication fee and upon the sorts of applications.

The radio communication terminal 1 has a function of confirming whether or not the radio access scheme as selected is usable. If the radio access scheme selected is usable, the radio communication terminal 1 may perform communication using the selected radio access scheme. If the radio access scheme selected is not usable, an alternative processing, such as a processing of limiting the communication, may be carried out. In short, the radio communication terminal 1 may confirm whether or not the radio access scheme selected is usable and accordingly determine whether or not the communication is to be carried out.

Since the radio access scheme is selected as the communication fee and the sorts of the applications are both taken into account, the radio communication terminal 1 may be controlled such as to prevent excessive increase in the communication fee due to communication corresponding to a predetermined application. If, in the radio communication terminal 1, the radio access scheme as selected is not usable, the radio communication terminal 1 may limit communication corresponding to a predetermined application, as an example.

On the other hand, as regards the communication for which a user requests continuity or sustainability of services, the radio communication terminal 1 may use radio access schemes that are usable, even though the communication fee is increased.

Hence, the radio communication terminal 1 may respond to specified user needs as the communication fee is suppressed.

The communication fee is the communication fee conforming to the volume of cumulative communication exploited by the radio communication terminal 1, as an example.

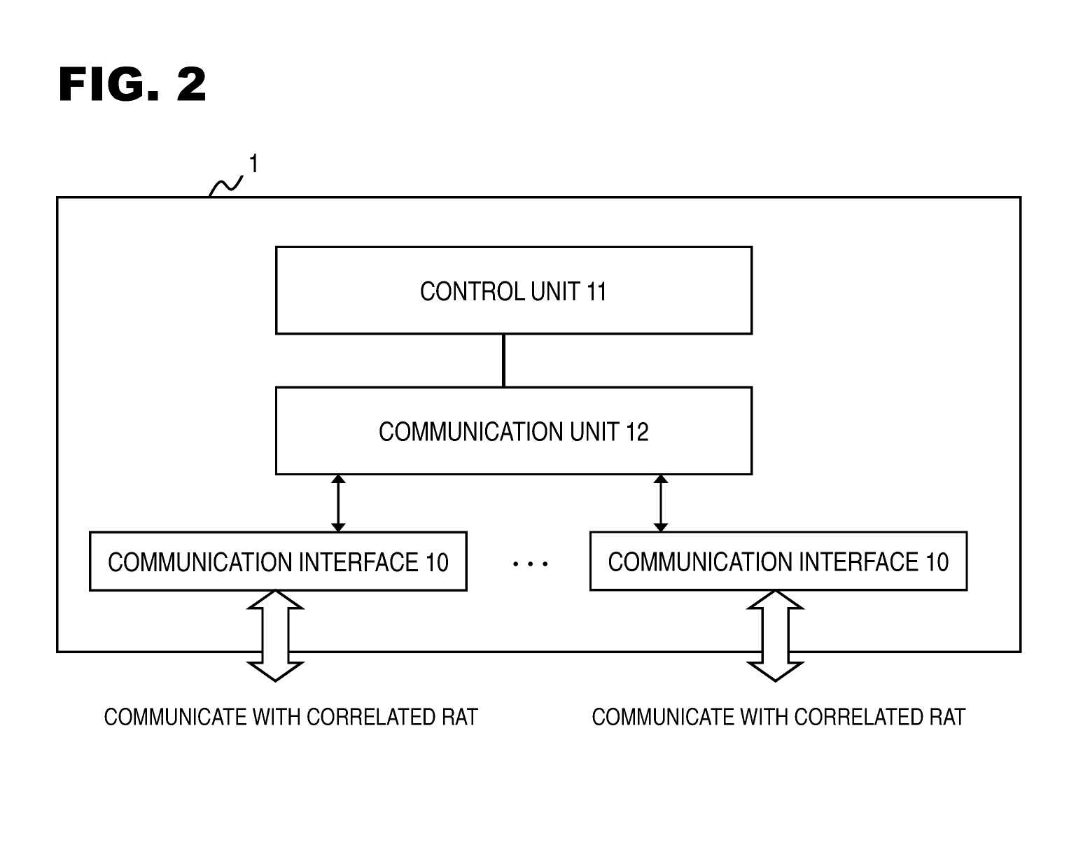

FIG. 2 shows an example configuration of the radio communication terminal 1.

The radio communication terminal 1 includes a plurality of communication interfaces 10, a control unit 11 and a communication unit 12. The communication interfaces 10 are each correlated to at least one of the radio access schemes. For example, the communication interface 10(A) is correlated to the E-UTRAN 4-2, the communication interface 10(B) is correlated to W-LAN 4-3 including IEEE802.11a, 802.11b, 802.11g and 802.11n.

The communication interfaces 10 may each be an antenna, and are each correlated to at least one of a plurality of RATs. For example, each communication interface 10 is correlated to a particular RAT, such as UTRAN 4-1, as an example. The radio communication terminal 1 connects to e.g., the particular RAT, such as UTRAN 4-1, as an example, via the communication interface 10. Also, for example, the communication interface 10 is correlated to a plurality of RATs, such as WLAN 4-3, 4-4. The radio communication terminal 1 then connects via the communication interface 10 to one of the correlated communication interfaces 1. It is also possible for a sole device, e.g., an antenna, to possess a plurality of the communication interfaces 10.

In communicating with any one of the RATs, the communication interface 10 does so via a base station 40 correlated to the RAT.

The control unit 11 selects the radio access scheme, used for communication, based upon both the communication fee corresponding to the communication volume and the sorts of the applications. The control unit 11 confirms whether or not the radio access scheme selected is usable. If the radio access scheme selected is usable, the control unit 11 instructs the communication unit 12 to use the so selected radio access scheme. The control unit confirms whether or not the radio access scheme selected is usable based upon whether or not the radio communication terminal 1 is connected to the radio access scheme selected or whether or not the radio communication terminal 1 may set up connection to the selected radio access scheme.

The communication unit 12 performs communication using the communication interface correlated to the radio access scheme decided on.

The control unit 11 monitors e.g., the volume of the communication due to the respective communication interfaces 10. The control unit 11 calculates the communication fee based upon the monitored communication volume. The control unit may get the communication fee from a communication operator.

As long as the communication fee is less costly, the control unit preferentially uses a radio access scheme which has a wide communication coverage area and which allows for stabilized communication (the interface correlated to a cellular network, such as UTRAN or E-UTRAN). Although the radio access scheme may be the subject of communication volume specific communication fee charging, it is possible for the control unit 11 to prioritize the quality of communication as long as the communication fee remains low.

The control unit 11 may exercise control so that the rate of using a radio access scheme with a free communication toll, such as WLAN interface, will become higher with increase in the communication fee.

The control unit 11 may also exercise control to select a radio access scheme whose communication fee is lower than in the radio access scheme currently used. For example, the control unit 11 may prioritize a less costly radio access scheme from among toll radio access schemes. The control unit 11 may exercise control to select a radio access scheme with flat-rate charging which does not regard the communication volume. Note that the toll radio access scheme may for example be a communication volume specific type charging system which charges in keeping with the communication volume.

The control unit 11 selects the radio access scheme as not only the communication fee but also the sorts of the applications are taken into account. For example, the control unit 11 may suppress using a toll radio access scheme for communication correlated to a predetermined application, in response to increasing communication fee, such as to promote using a toll-free or less costly radio access scheme. Such toll-free or less costly radio access scheme may be exemplified by toll-free Wi-Fi (Wireless Fidelity) or by a radio access scheme which charges by a flat-rate charging system without taking account of the communication volume.

The control unit 11 may suppress using a toll radio access scheme for a predetermined communication application even though the communication fee is low. The radio communication terminal 1 may have on board such an application that allows the communication unintended by the user to be run in the background. Even though the communication fee is not in excess of a predetermined reference amount, the control unit 11 may suppress using the toll radio access scheme for a communication executed in the background. Such function is effective to avoid the cumulative communication volume from increasing excessively due to frequent running of the background communication.

The control unit 11 may allow using the toll radio access scheme even in case the communication fee is higher than a predetermined reference value. For example, the control unit 11 may allow using a toll radio access scheme for an application performing highly emergent communication even though the communication fee is increased.

The control unit 11 may select a plurality of radio access schemes as candidates of the radio access schemes the radio communication terminal uses.

In case the radio access scheme, selected based upon both the communication fee and the sorts of the applications, is not usable, the control unit 11 may limit the communication. For example, if a user whose communication fee has exceeded a predetermined amount has attempted using an application that accesses a movie, the control unit selects a toll-free radio access scheme. If the toll-free radio access scheme is unusable, the control unit 11 may limit using the application to access a movie. To limit using an application, the control unit 11 may, for example, drop a packet.

In case the radio access scheme selected is not usable, the control unit 11 may allow having communication by a predetermined application using a usable radio access scheme. For example, if a user whose communication fee has exceeded a predetermined value attempts using a text message, the control unit may allow communication by a usable radio access scheme even in case the communication fee charging system is communication volume specific type charging which charges in keeping with the communication volume.

The communication unit 12 transfers a packet to the communication interface correlated to the radio access scheme as decided on by the control unit 11. In short, the communication unit 12 switches from the communication interface currently used to the communication interface correlated to the radio access scheme as selected depending upon the communication fee.

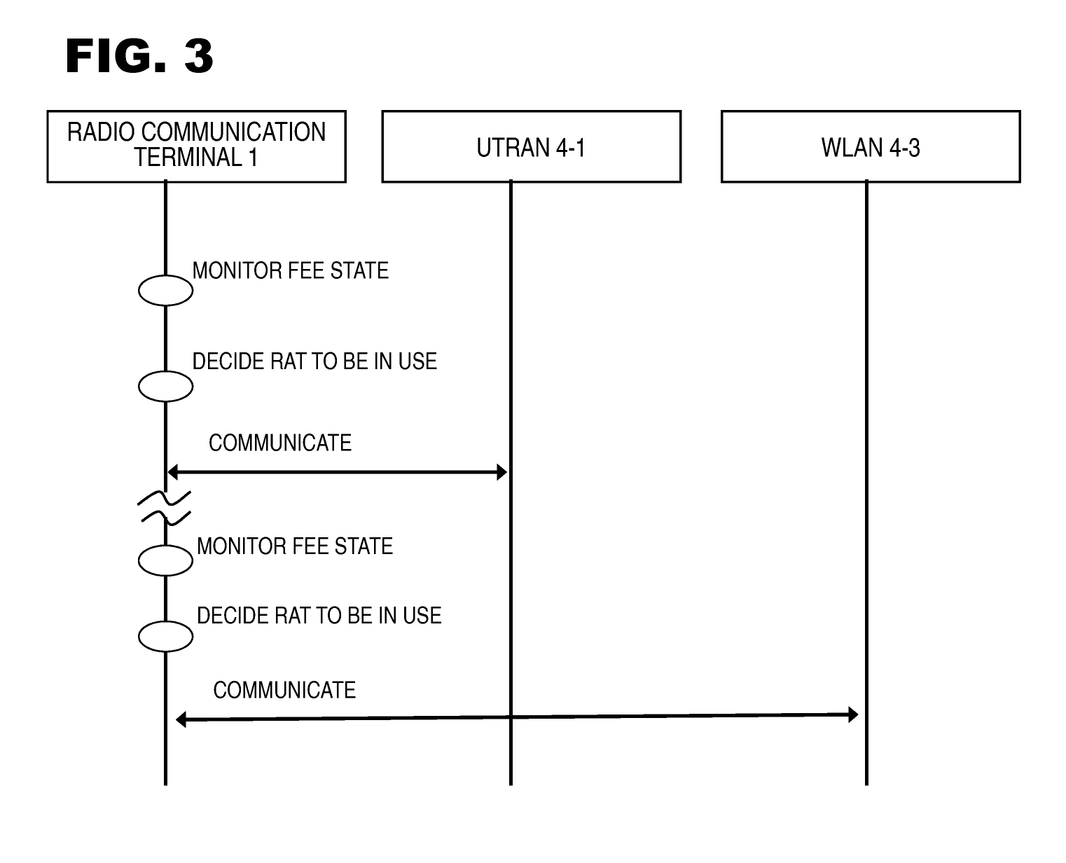

FIG. 3 shows an example operation of the first exemplary embodiment.

The radio communication terminal 1 monitors the status of the communication fee. The radio communication terminal 1 confirms whether or not the radio access network selected based upon the communication fee and the application sort is usable. If the radio access network selected is usable, the radio communication terminal 1 performs communication with an access network using a communication network correlated to the so selected radio access network.

The radio communication terminal 1 repeatedly executes the above mentioned operations, for example, at a predetermined period. The radio communication terminal 1 may also execute the above mentioned operations at an optional timing.

### Second Exemplary Embodiment

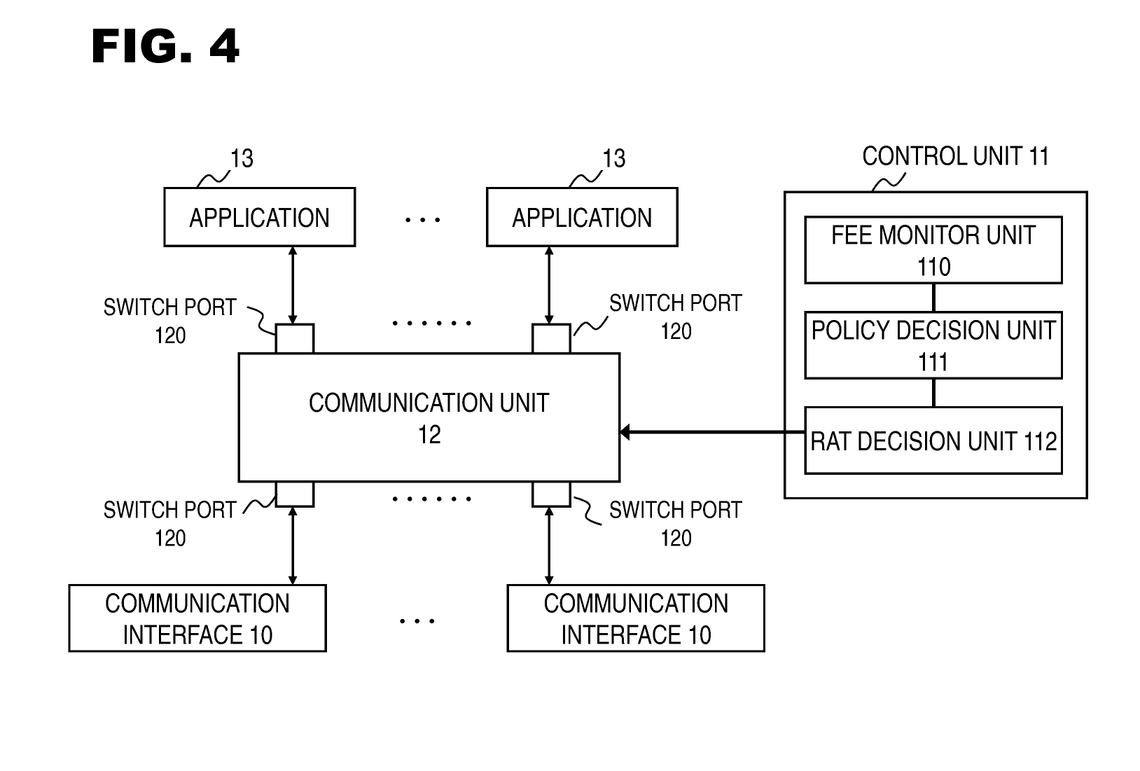

FIG. 4 shows an example configuration of a radio communication terminal 1 in a second exemplary embodiment.

The radio communication terminal 1 comprises a plurality of applications 13. Each application 13 connects to the communication interface 10 via a communication unit 12. The applications 13 may, for example, be a Web browser, a mailer for e-Mail or a software piece for SNS (Social Networking Service).

A control unit 11 includes a fee monitor unit 110, a policy decision unit 111, and a RAT decision unit 112.

The fee monitor unit 110 monitors the volume of communication for each of the communication interfaces 10 to calculate the communication fee based upon the so monitored communication volume. In short, the fee monitor unit 110 calculates the communication fee correlated to the cumulative communication volume at the radio communication terminal 1. The cumulative communication volume is the communication volume within a predetermined period, as an example. The cumulative communication volume may be the communication volume per day, per week, or per month. It may also be the communication volume per hour.

It is presupposed that the fee monitor unit 110 recognizes a per-packet fee from a notification from a communication operator with whom the user has entered into a contract. The fee monitor unit 110 calculates the communication fee by multiplying the per-packet fee with the communication volume.

The fee monitor unit 110 may receive the communication fee calculated by the communication operator from the communication operator. The fee monitor unit 110 may receive the information concerning the communication fee from the communication operator at a predetermined period. For example, the fee monitor unit 110 may also request the information concerning the communication fee from the communication operator at an optional timing.

The policy decision unit 111 decides on a policy, used in deciding on a radio access scheme, depending on the status of the communication fee.

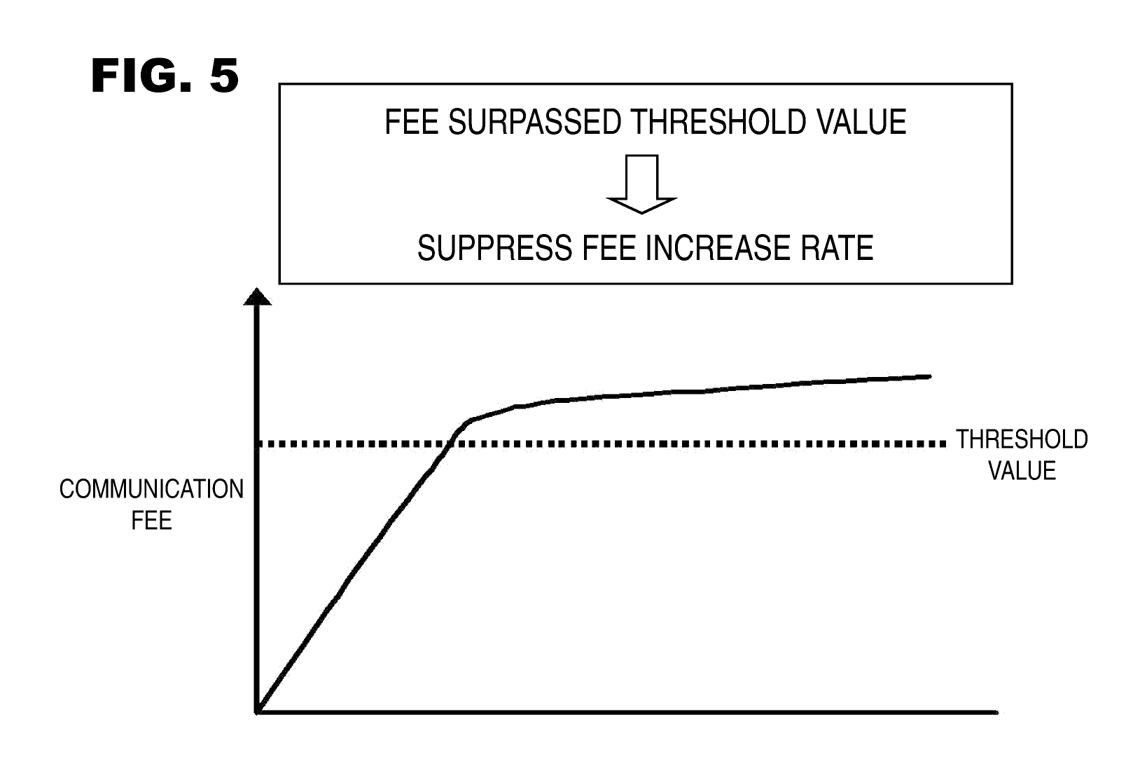

FIG. 5 shows an example policy decided on by the policy decision unit 111.

The policy decision unit 111 decides on a policy, which may read “suppress the rate of increase of the communication fee when the communication fee has exceeded a predetermined threshold value.” The rate of increase of the communication fee is an increment of the communication fee during a predetermined period, as an example. The RAT decision unit 112 may operate in accordance with a policy such as to increase the rate of use of a toll-free radio access scheme or a less costly radio access scheme in case the communication fee has exceeded a threshold value. The RAT decision unit 112 may also decrease the rate of use of the toll radio access scheme in accordance with the policy.

The policy decision unit 111 may also decide on a policy which suppresses the communication fee from increasing in case the rate of increase of the communication fee has exceeded a predetermined threshold value. Thus, the RAT decision unit 112 may increase the rate of use of the toll-free radio access scheme or the less costly radio access scheme in case the rate of use of the communication fee within a predetermined period, such as per-day, per/week, or per/month rate of use, has exceeded a predetermined threshold, in accordance with the policy.

In case the policy decision unit 111 is unable to use the radio access scheme, as selected in accordance with a policy, the policy decision unit may decide on a policy which limits the communication.

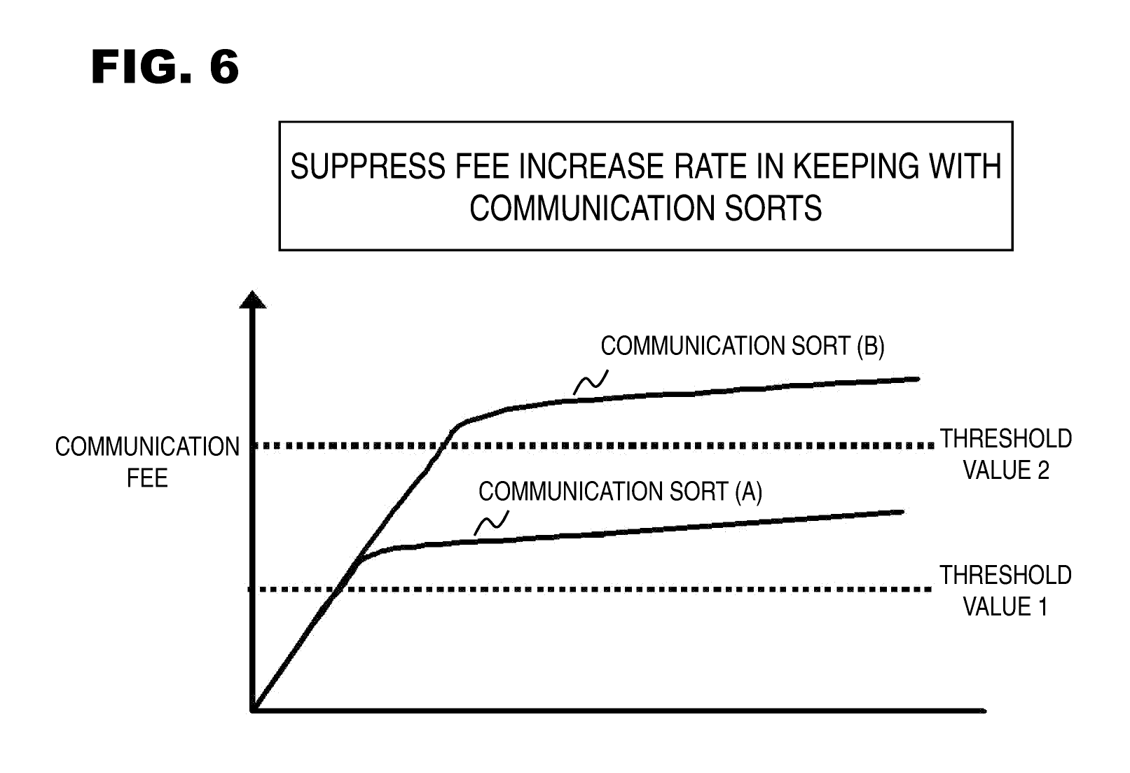

FIG. 6 shows an example policy decided on by the policy decision unit 111.

The policy decision unit 111 may decide on a policy based upon a threshold value as set from one sort of communication to another. The sort of communication is correlated to the sort of the communication application 13, as an example. The policy decision unit 111 may thus decide on a policy which may read “suppress the rate of increase in the communication fee due to a communication sort (A) in case the communication fee has exceeded a predetermined threshold value.” For example, in case the communication fee has exceeded a threshold value correlated to the communication sort (A), the RAT decision unit 112 increases the rate of use of the toll-free radio access scheme or the less costly radio access scheme, in accordance with the policy.

The policy decision unit 111 may decide on a policy which limits the communication for a predetermined communication sort in case the communication fee has exceeded a predetermined threshold value. The policy decision unit 111 may also limit the use of a predetermined radio access scheme, for example, a radio access scheme of communication volume specific type charging, without dependency upon the communication sort, in case the communication fee has exceeded a predetermined threshold value.

The policy decision unit 111 may decide on a policy in which radio access scheme selection is made for a predetermined communication sort without setting a threshold value and without regard to the communication fee correlated to the cumulative volume of communication.

In the example of FIG. 6, radio access scheme selection is made as the communication fee and the sorts of communication are both taken into account. Thus, in the radio communication terminal 1, radio access scheme selection may be made such as to suppress the communication fee due to predetermined communication, whilst radio access scheme selection may be made in favor of high radio access scheme quality for communication for which stability is a desideratum.

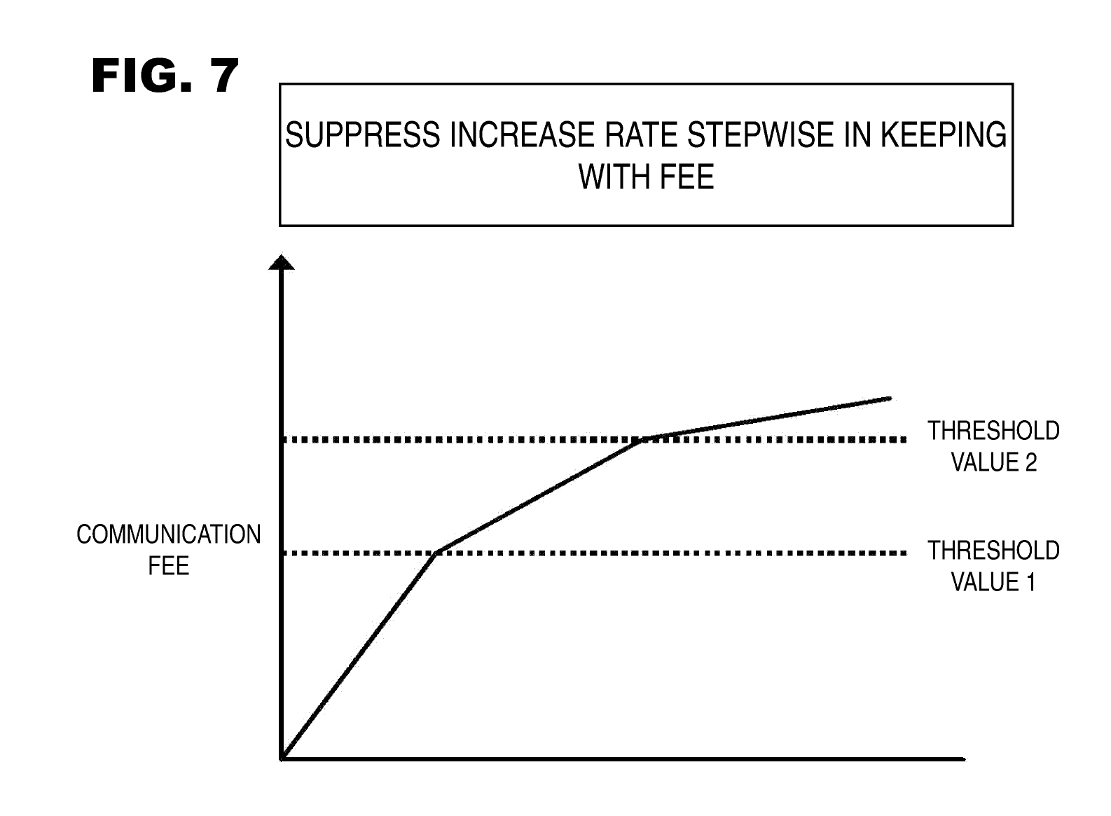

FIG. 7 shows another example policy decided on by the policy decision unit 111.

The policy decision unit 111 may set a plurality of threshold values and decide on a policy which may read “suppress the rate of increase of the communication fee stepwise each time the communication fee has exceeded each threshold value.” The policy decision unit 111 may set the policy, such as that shown in FIG. 7 as an example, for each sort of communication. The RAT decision unit 112 may thus increase the rate of use of the toll-free or less costly radio access scheme stepwise each time the communication fee has exceeded the threshold value for each communication sort. The less costly radio access scheme may be exemplified by a flat-rate system which charges without dependency upon the communication volume. The RAT decision unit 112 may also decrease the rate of use of the toll radio access scheme stepwise each time the communication fee has exceeded the threshold value for each communication sort.

The RAT decision unit 112 may also suppress the use of the toll radio access scheme even in case the communication fee has not reached the threshold value as set by the policy decision unit 111.

The policy decision unit 111 may also decide on a policy by combination of the methods set out above with reference to FIG. 5, FIG. 6 and FIG. 7.

The above mentioned policies may be set by a user of the radio communication terminal 1 actuating the policy decision unit 111.

The RAT decision unit 112 may also limit the communication in case the radio access scheme as selected by a policy decided on by the policy decision unit 111 is unusable. For example, if the toll-free radio access scheme selected is unusable, the RAT decision unit 112 may limit the use of the toll radio access scheme by communication whose priority level is low. If the toll-free radio access scheme is unusable and the use of the toll radio access scheme is limited, communication is limited, however, it is possible to avoid the communication fee from increasing excessively.

For example, if the radio access scheme selected by the policy as decided on by the policy decision unit 111 is unusable, the RAT decision unit 112 may use other radio access schemes. For example, if the toll-free radio access scheme as selected is unusable, the RAT decision unit 112 may use usable radio access scheme(s). Moreover, if the toll-free radio access scheme selected is unusable, the RAT decision unit 112 may allow just a specified application to use the usable radio access scheme. For example, even in case the usable radio access scheme is a toll system, the RAT decision unit 112 may allow the radio access scheme to be used by such specified application.

The RAT decision unit 112 may notify the communication unit 12 about the radio access scheme used for the communication.

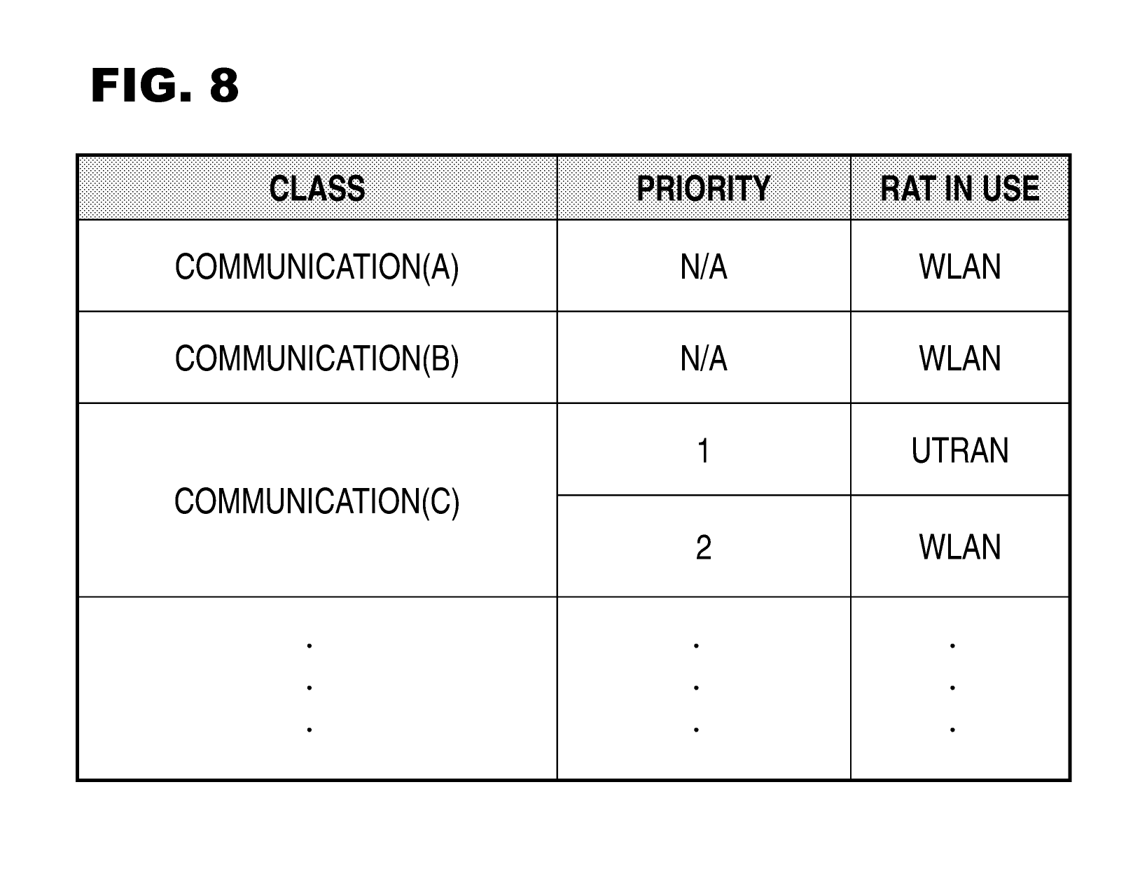

FIG. 8 shows several information examples notified from the RAT decision unit 112 to the packet processing unit 12.

The RAT decision unit 112 notifies the radio access scheme used from one communication sort to another. In the example of FIG. 8, the RAT decision unit 112 specifies WLAN, for the communication (A), as the radio access scheme used.

The RAT decision unit 112 may decide on a plurality of radio access schemes for a specified communication and donate different values of the priority level to the plural radio access schemes. For example, for the communication (C), the RAT decision unit 112 may decide on either UTRAN or WLAN, as the radio access scheme to be in use, as in the example shown in FIG. 8. The RAT decision unit 112 sets the priority level of UTRAN, which is the radio access scheme used for the communication (C), so as to be higher than that of WLAN.

The communication unit 12 includes a plurality of switch ports 120. Each application 13 and each communication interface 10 are correlated to one of the switch ports 120. The communication unit 12 manages the relationship of correspondence between the applications 13 and the communication interfaces 10 based upon a notification from the RAT decision unit 112.

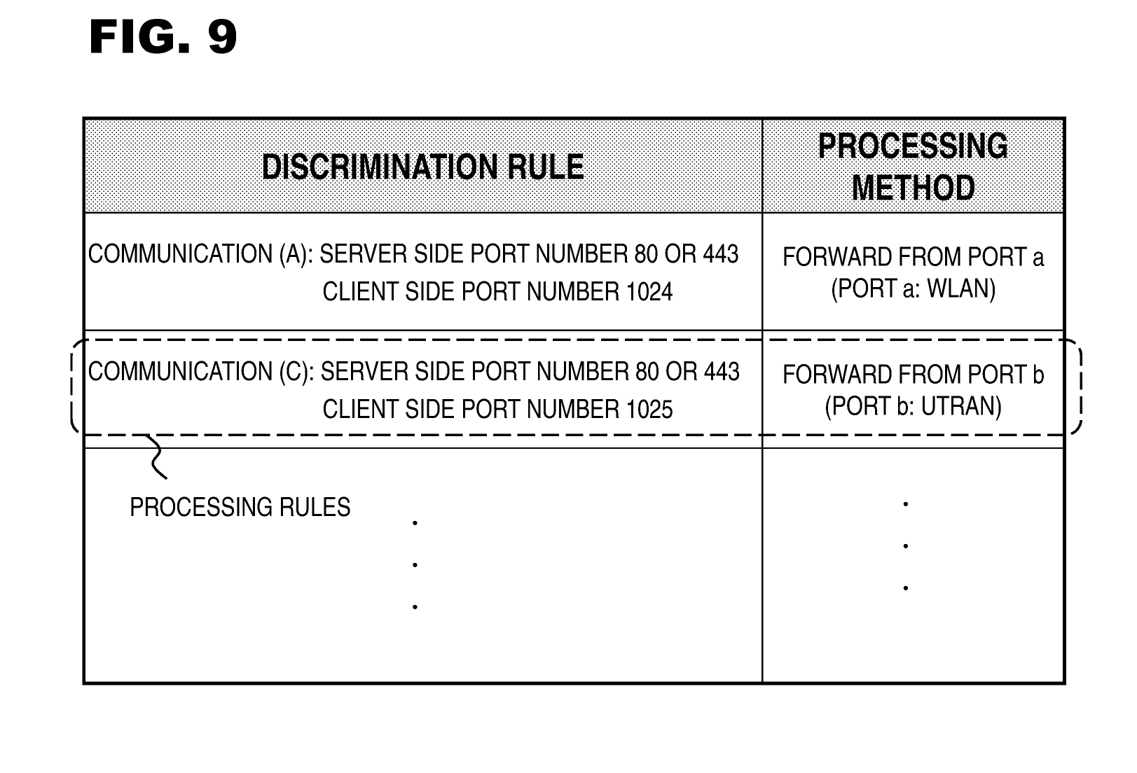

FIG. 9 shows examples of the information managed by the communication unit 12. The RAT decision unit 112 may also notify the communication unit 12 about the information exemplified in FIG. 9.

The communication unit 12 switches among the communication interfaces 10, from one communication sort to another, based upon the information including both communication discrimination rules and the communication processing methods matched to the discrimination rules. This information is a set of processing rules. The communication unit 12 holds a table that contains a plurality of such processing rule sets.

The communication unit 12 discriminates among the communication sorts correlated to the applications 13 based upon port numbers, as an example. In the example of FIG. 9, the communication unit 12 discriminates among the communication sorts based upon a server side port number and a client side port number. For example, if the server side port number is “80” and the client side port number if “1024,” the communication unit 12 discriminates the communication to be of the communication sort (A). The communication unit 12 forwards the packet, belonging to the communication sort (A), from a port “a” correlated to WLAN, in accordance with the processing rule set.

In the example of FIG. 8, the RAT decision unit 112 notifies the packet processing unit 12 about a plurality of radio access scheme candidates for a communication sort (C). The communicating unit 12 scans the radio access schemes to discriminate a usable one of the radio access schemes notified from the RAT decision unit 112. The packet processing unit 12 uses, for the communication sort (C), one of the usable radio access schemes which is higher in the priority level, as an example. In the example of FIG. 9, the communication unit 12 forwards the packet belonging to the communication sort (C) from a port “b” correlated to UTRAN. It is also possible for the RAT decision unit 112 to scan the usable radio access schemes to decide on one of the multiple radio access scheme candidates that is to be in use. The RAT decision unit 112 may also prepare a processing rule set based upon the decision on the radio access scheme to notify the communication unit 12 about the so prepared processing rule set.

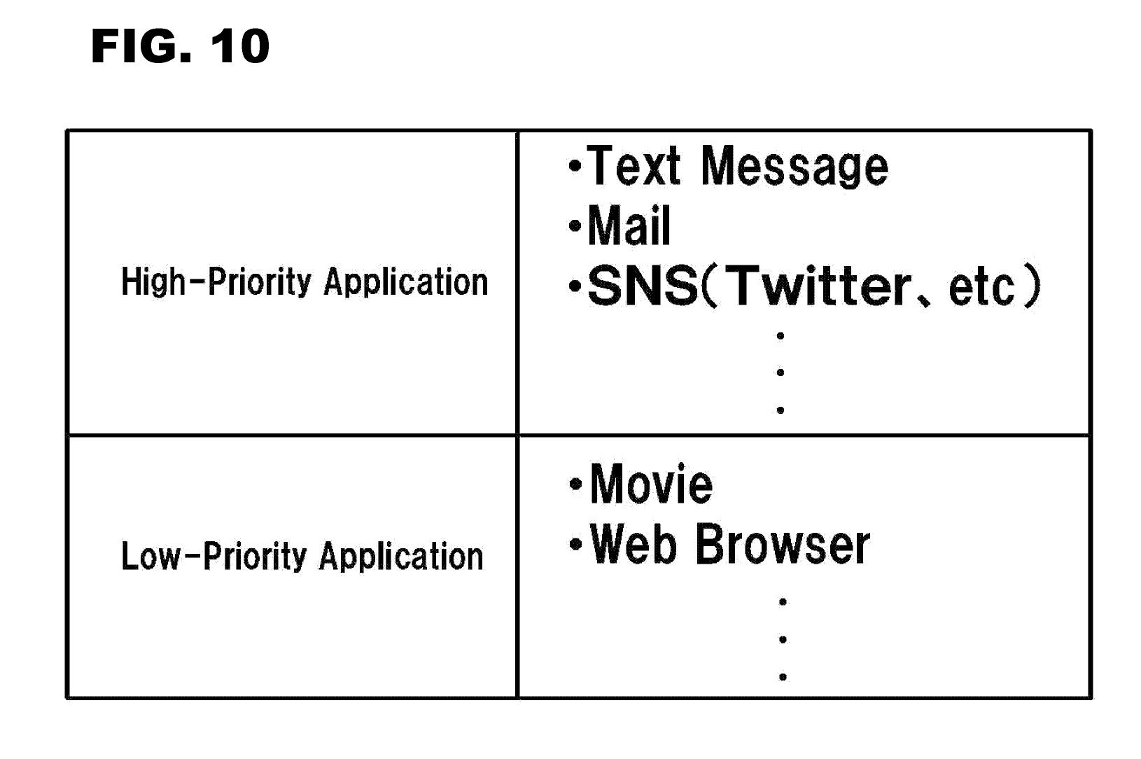

The priority level values may be predetermined in the control unit 11 from one application 13 to another, as in the example shown in FIG. 10. It is possible for the policy decision unit 111 and the RAT decision unit 112 to control the use of the RAT in dependency upon the communication fee, according to the above mentioned method, based upon the values of the priority level from one application 13 to another.

The control unit 11 exercises control so that, even in case the communication fee has exceeded the predetermined threshold value, the communication for the application 13 with a higher priority level will not be suppressed. For example, even in case the communication fee has exceeded a predetermined threshold value, the control unit 11 uses a toll radio access scheme for the communication for the application 13 having the higher priority level. Such toll system may be exemplified by that of a cellular network encompassing a broad coverage area, such as UTRAN or E-UTRAN.

The control unit 11 may decide on the RAT to be in use, depending on whether or not there exists the usable toll-free or less costly radio access scheme, such as Wi-Fi, in case the communication fee has exceeded a predetermined threshold value. For example, the control unit 11 may use a toll-free radio access scheme, without regard to the priority level, in case there exists a usable toll-free radio access scheme(s), such as Wi-Fi. Should there exist no toll-free radio access scheme(s), the control unit 11 may use a toll radio access scheme for communication for the application 13 having the priority level higher than a predetermined reference level, such as, for example, the application of ‘High Priority’. The control unit 11 may set a high priority level for applications for which the communication volume is not that much and which users request to use oftentimes, such as text messages or e-mails. In short, even in case there is no toll-free or less costly radio access scheme, the control unit 11 may continue its communication, using the usable radio access scheme, thereby maintaining the communication for the application(s) 13 having a high priority level. Hence, even granting that the communication fee is increased, user friendliness may be maintained.

In case the communication fee has exceeded a predetermined threshold value, the control unit 11 may limit the use of the toll radio access scheme for the application(s) 13 having a low priority level. For example, the control unit 11 may impose limitations on the use of the toll radio access scheme by an application(s) whose communication volume is estimated to be an enormous value, such as movie streaming.

A user of the radio communication terminal 1 may set the degree of priority, shown as examples in FIG. 10, in the control unit 11. For example, the user sets the degree of priority for each application 13 in the control unit 11 using a UI (User Interface) that sets the priority level.

In the second exemplary embodiment, the radio communication terminal 1 selects the radio access scheme correlated to the communication fee from one communication sort to another. It is thus possible in the second exemplary embodiment to prevent wasting the communication fee in e.g., the communication volume specific type charging system as user friendliness is maintained.

### Third Exemplary Embodiment

In a third exemplary embodiment, the radio communication terminal 1 receives a policy of selecting the radio access scheme in keeping with the communication fee from a policy control server 5 residing on a network 3. The third exemplary embodiment may be applied to any of the above described exemplary embodiments.

In the third exemplary embodiment, the load imposed on the user in connection with policy management may be relieved. Moreover, in the third exemplary embodiment, it is possible for the communication operator to render services related to control of the communication fee due to a user exploiting the communication volume specific charging system.

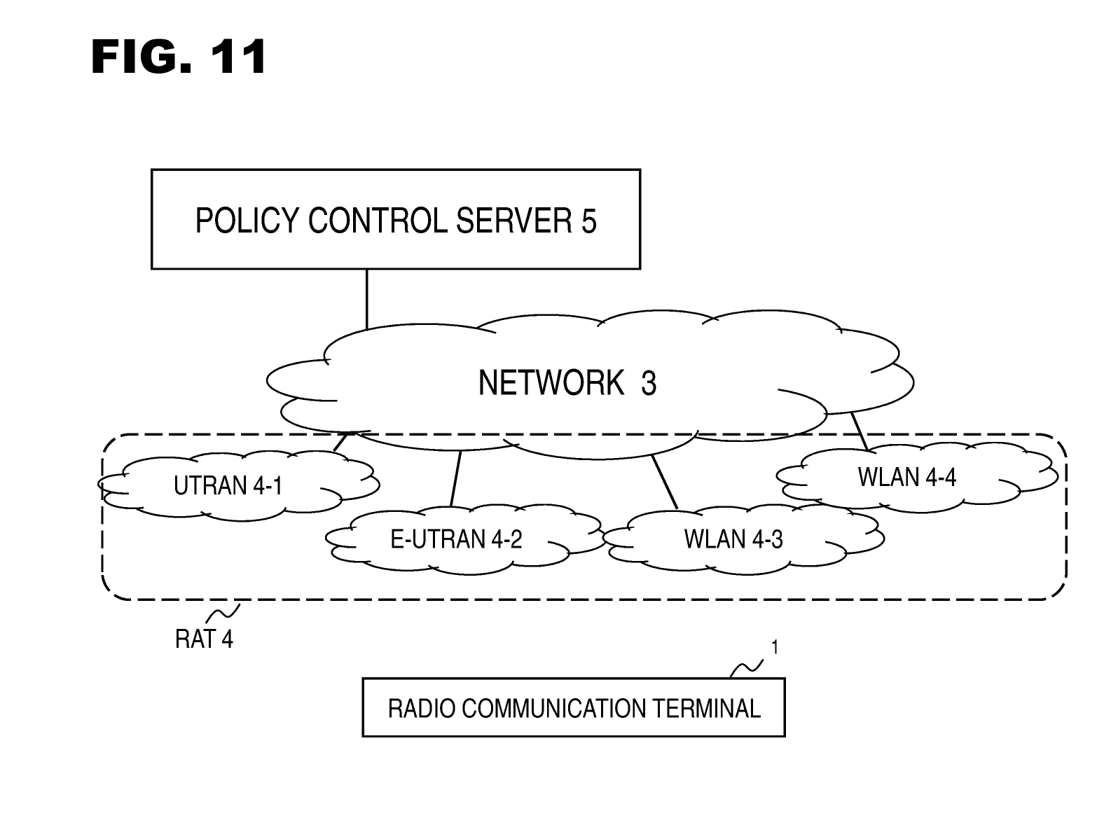

FIG. 11 schematically shows an example system configuration of the third exemplary embodiment.

In the third exemplary embodiment, the policy control server 5 notifies the radio communication terminal 1 about the policy of selecting the radio access scheme depending on the communication fee.

The policy control server 5 is physically isolated from the radio communication terminal 1. Note that the policy control server 5 need not necessarily be in a location shown in FIG. 11 and may also be in an access network for each RAT. The policy control server 5 may also be installed in a data center that may have communication with the network 3.

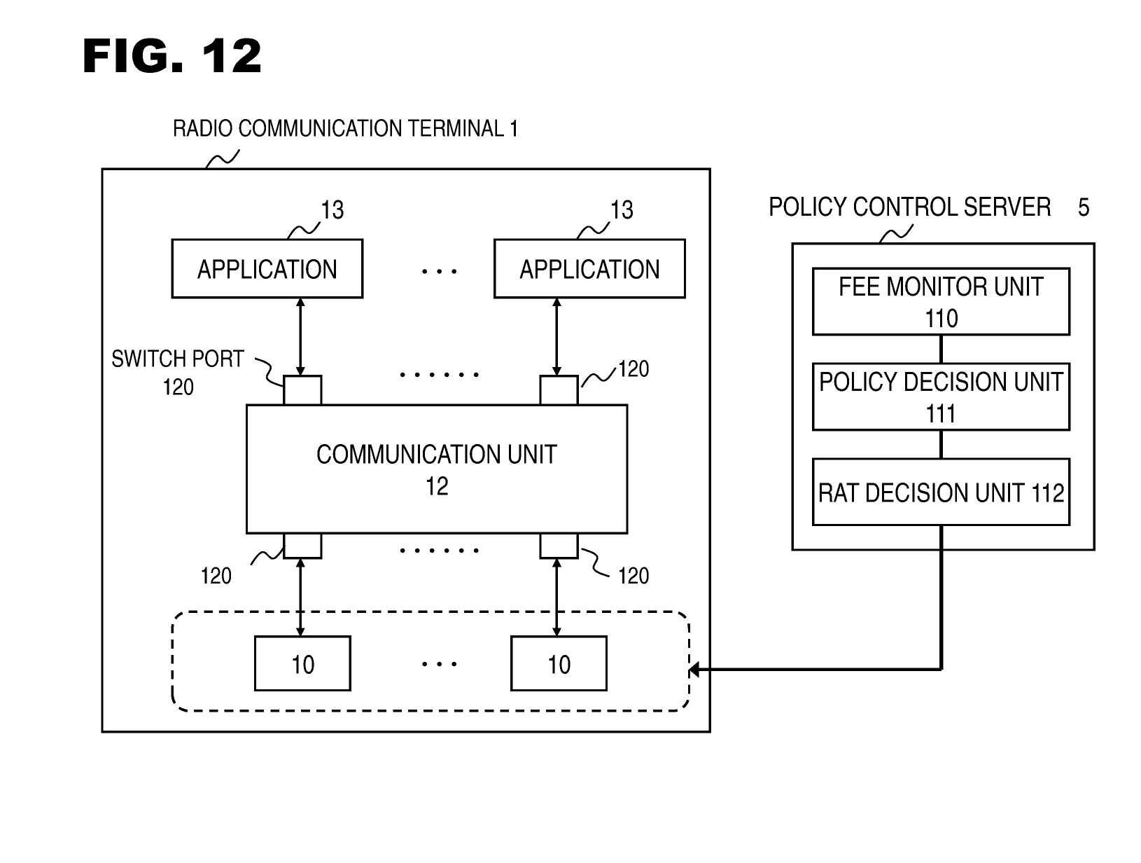

FIG. 12 shows example configurations of the radio communication terminal 1 and the policy control server 5.

The policy control server 5 has the functions corresponding to those of the control unit 11 shown in FIG. 2 and FIG. 4.

The policy control server 5 selects the radio access scheme the radio communication terminal 1 is allowed to use. The method of selecting the radio access scheme by the policy control server 5 is the same as that of the above described exemplary embodiment. The policy control server 5 notifies the communication unit 12 about the selected radio access scheme 1 via the communication interface 10 of the radio communication terminal 1.

### Fourth Exemplary Embodiment

In a fourth exemplary embodiment, the present invention is applied to a technique adapted from a technique known as the OpenFlow which represents a centralized control system network architecture.

The fourth exemplary embodiment may be applied to any of the above described exemplary embodiments.

The OpenFlow recognizes communication as end-to-end flow and is able to exercise e.g., path control on the flow-by-flow basis. The present invention may thus use the OpenFlow to more flexibly control the radio access scheme in keeping with the communication fee.

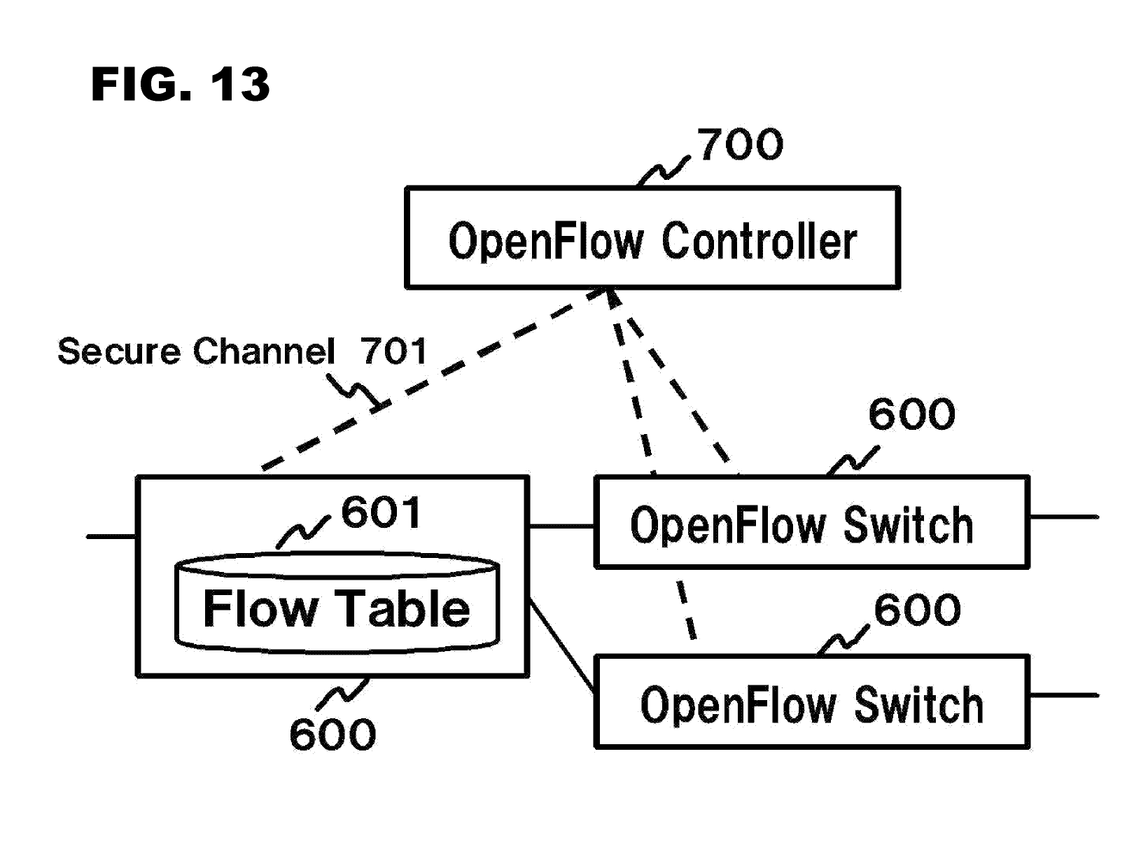

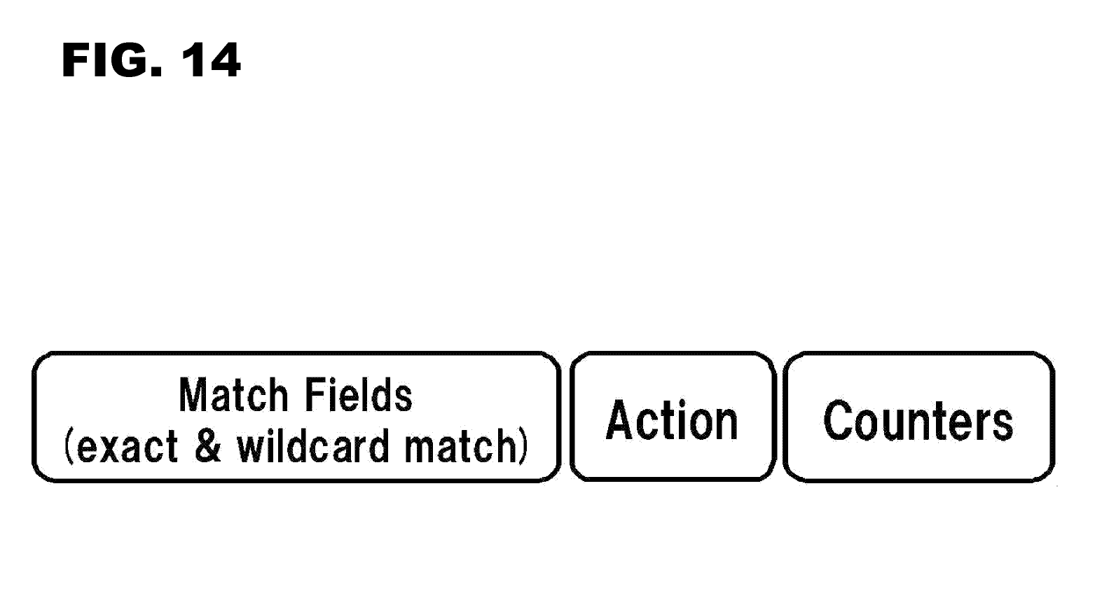

The OpenFlow will now be explained with reference to FIG. 13 and FIG. 14.

FIG. 13 shows schematics of a communication system constructed in accordance with the OpenFlow technique. Note that a flow means a train or sequence of communication packets having predetermined attributes, that is, attributes identified based upon the destination or the source of communication. An OpenFlow switch 600 is a network switch that uses the OpenFlow technique, an OpenFlow controller 700 is an information processing apparatus that controls the OpenFlow switch 600.

The OpenFlow switch 600 performs communication with the OpenFlow controller via a secure channel 701 provided between the OpenFlow switch and the OpenFlow controller 700. The OpenFlow controller 700 sets a flow table 601 of the OpenFlow switch 600 via the secure channel 701. Note that the secure channel 701 is a communication path provided with a means to prevent eavesdropping or counterfeiting of communication between the switch and the controller.

FIG. 14 schematically shows an example configuration of each entry (flow entry) of the flow table 601. The flow entry comprises matching rules, counters (Counters) and an Action(s) (Actions). The matching rules are used in matching against the information, such as destination IP addresses or VLAN IDs, contained in the header information of packets received by the switch. The counters are the statistic information for each packet flow, and the action specifies a method for processing a packet matched to the matching rules.

On receipt of a packet, the OpenFlow switch 600 refers to the flow table 601. The OpenFlow switch 600 searches for a flow entry that matches to the header information of the packet received. In case the entry matched to the header information of the received packet has been retrieved, the OpenFlow switch 600 processes the received packet in accordance with the processing method defined in the action field of the entry retrieved. The processing method may, for example, read “forward the received packet from a predetermined port,” “drop the packet received” or “rewrite part of the header of the received packet and forward from a predetermined port.”

If the entry matched to the header information of the packet received is not found, the OpenFlow switch 600 forwards the received packet to the OpenFlow controller 700 over the secure channel 701, as an example. The OpenFlow switch 600 by forwarding the received packet in this manner requests the controller to set a flow entry specifying the method for controlling the received packet.

The OpenFlow controller 700 decides on the method for processing the received packet and sets a flow entry, containing the processing method, thus decided on, in the flow table 601. The OpenFlow switch 600 then processes following packets belonging to the same flow as the received packet by the flow entry thus set.

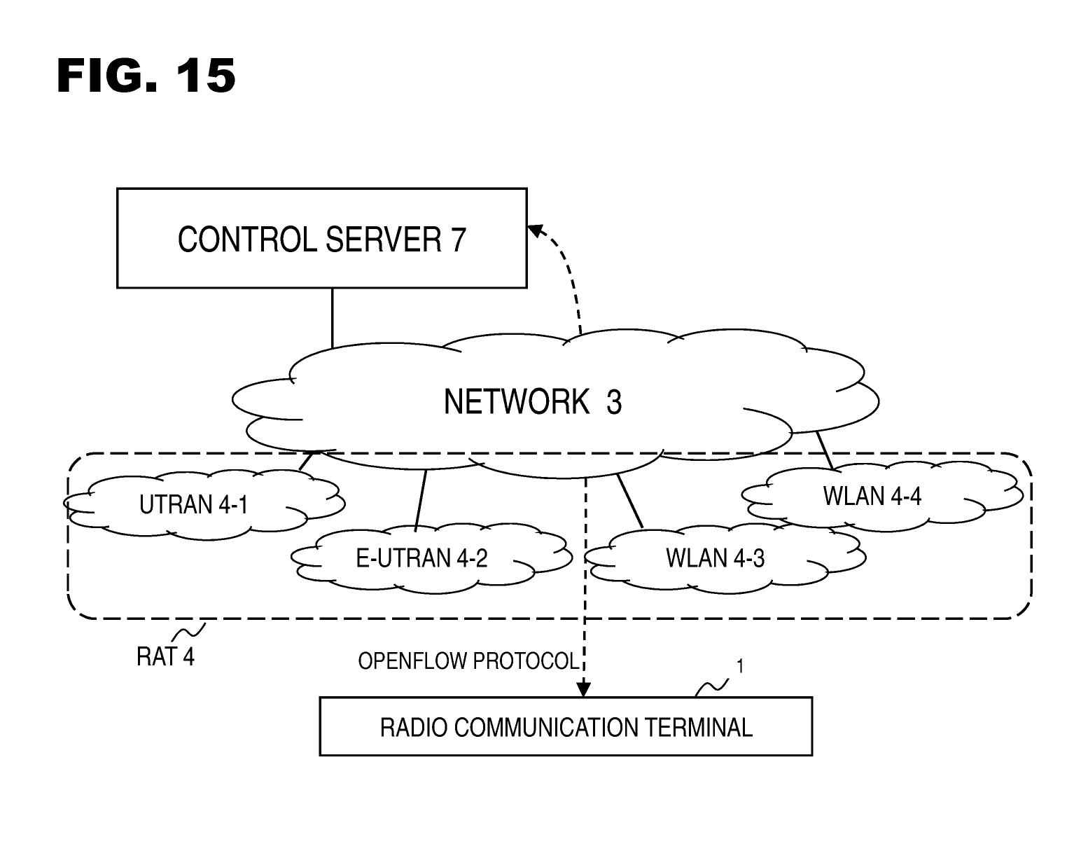

FIG. 15 schematically shows an example of the communication system of the fourth exemplary embodiment of the present invention adapted from the OpenFlow system described above.

A control server 7 has been adapted from the OpenFlow controller 700. The radio communication terminal 1 also has a function that is adapted from the OpenFlow switch 600. The radio communication terminal 1 performs communication with the control server 7 in accordance with the OpenFlow protocol.

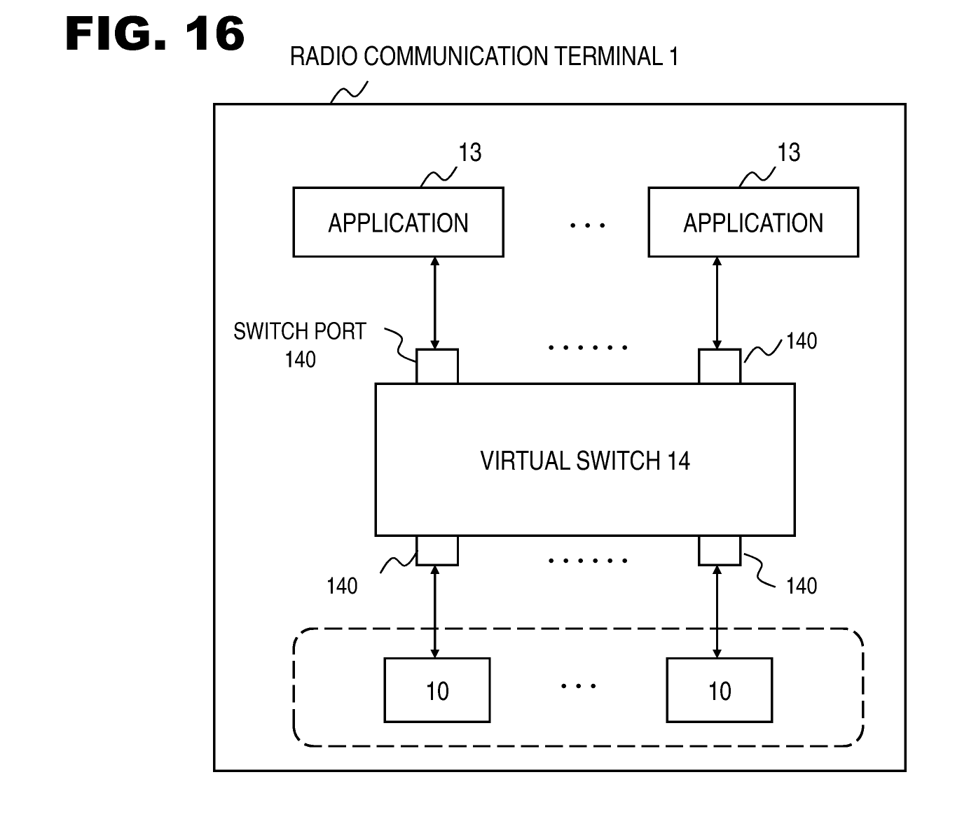

FIG. 16 shows an example configuration of the radio communication terminal 1 according to the fourth exemplary embodiment.

The radio communication terminal 1 includes a virtual switch 14 adapted from the OpenFlow switch 600. Although the virtual switch 14 is constructed by software, it may also be constructed by hardware in the context of the present invention.

The virtual switch 14 has the function similar to that of the communication unit 12 shown as an example in FIG. 2 and FIG. 4. The virtual switch 14 also has the function to perform communication with the control server 7 in accordance with the OpenFlow protocol. The virtual switch 14 performs communication, based upon instructions from the control server 7, using the radio access scheme as selected by the control server 7.

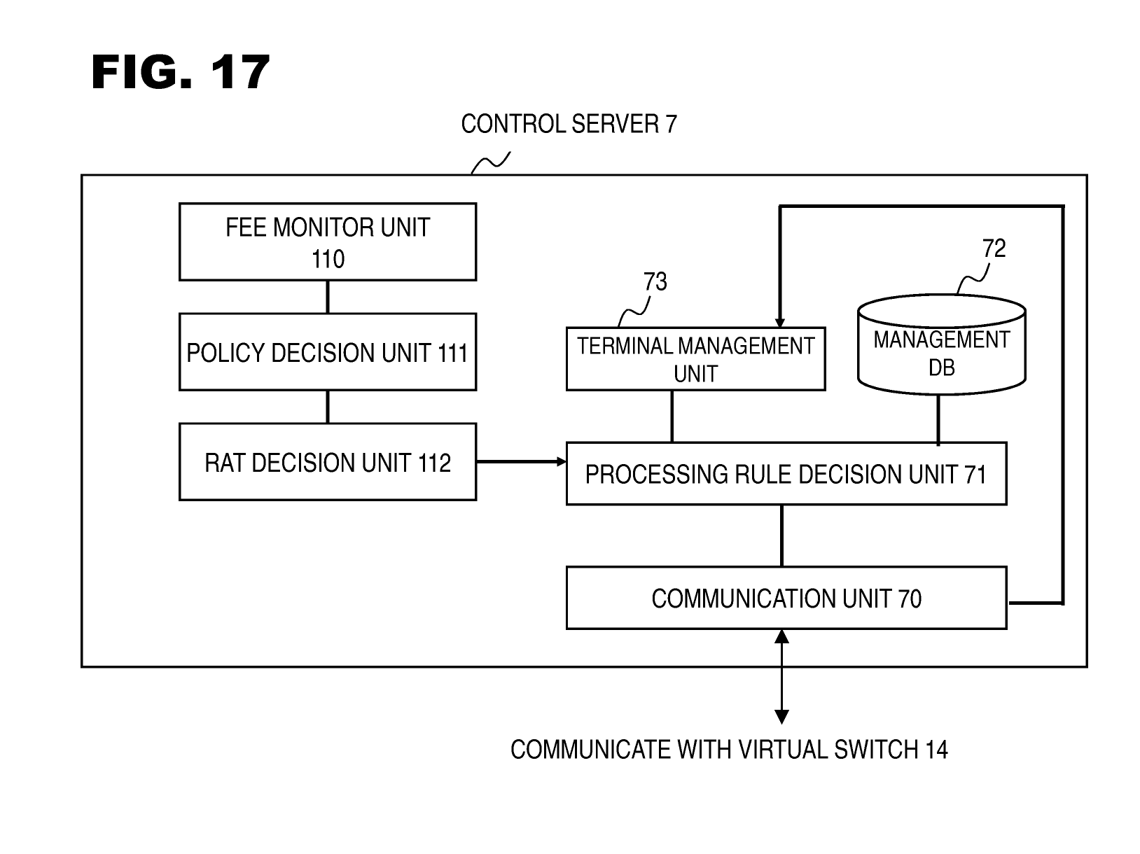

FIG. 17 shows an example configuration of the control server 7.

The control server 7 includes the fee monitor unit 110, policy decision unit 111, and the RAT decision unit 112. The units 110, 111, and 112 possess the functions like those of the exemplary embodiments described above. The fee monitor unit 110 manages the communication fee of the radio communication terminal 1. The fee monitor unit 110 gets the communication fee due to the radio communication terminal 1 from a communication operator, as an example. The fee monitor unit 110 acquires the communication fee from the communication operator at a predetermined period, as an example. The fee monitor unit 110 may also acquire the communication fee at an optional timing from the communication operator.

A processing rule decision unit 71 generates the processing rule set, to be set on the virtual switch 14, based upon the radio access scheme the RAT decision unit 112 decided on in keeping with the status of the communication fee.

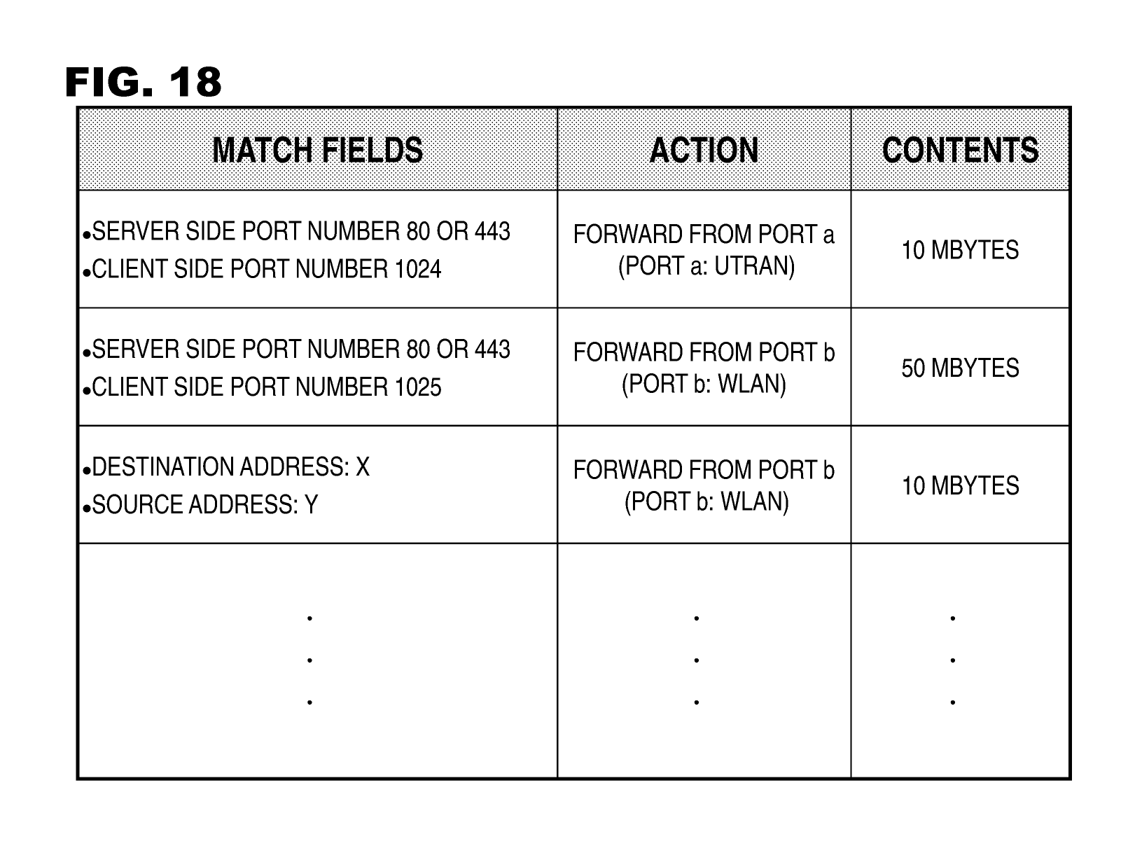

FIG. 18 shows several example sets of the processing rules. The processing rule sets correspond to the flow entries of the OpenFlow, as an example.

The “Match Fields” is for conditions in flow discrimination. The condition for discriminating the flow by a communication port number or the condition for discriminating the flow based upon the information contained in a packet, such as a destination address or a source address, for example, is set in the “Match Fields.” In an example shown in FIG. 18, a condition which may read “the destination address is ‘X’ and the source address is ‘Y’” is set in the “Match Fields.”

‘Action’ is for a method for processing a packet belonging to a flow matched to the condition of “Match Fields.”

‘Counter’ is for the quantity of processing of the flows matched to “Match Fields,” such as the number of packets or the processed volume expressed in numbers of bytes.

A terminal management unit 73 manages the relationship of correspondence between the communication interfaces 10 of the radio communication terminal 1 and switch ports 140 correlated to the respective interfaces. The terminal management unit 73 recognizes the relationship of correspondence between the communication interfaces 10 and the switch ports 140 by a report from the radio communication terminal 1. The terminal management unit 73 manages the relationship of correspondence between the communication interfaces 10 and the switch ports 140 from one identifier of the radio communication terminal 1, such as IMSI (International Mobile Subscriber Identity), to another.

The communication equipment constructed in accordance with the OpenFlow, such as network switch, has a function to notify the controller about the statuses of the ports of the communication equipment (Port Status) as well as a function to notify the controller about the switch features (Feature Request/Reply). The terminal management unit 73 may manage the relationship of correspondence between the communication interfaces 10 and the switch ports 140 of the virtual switch 14 based upon the information notified by those functions.

The terminal management unit 73 receives reports on client side port numbers allocated to the respective applications 13 from the radio communication terminal 1. The terminal management unit 73 manages the client side port numbers, allocated to the respective multiple applications 13, from one identifier of the radio communication terminal 1 to another. The radio communication terminal 1 may exploit the function of “Port Status” or “Feature Request/Reply,” for example, in order to inform the terminal management unit 73 about the client side port numbers.

The processing rule decision unit 71 receives, from the RAT decision unit 112 as an example, an instruction to switch the radio access scheme for a flow whose communication fee has exceeded a predetermined threshold value. The processing rule decision unit 71 decides on the condition to discriminate the flow correlated to the instruction, and sets the condition, thus decided on, in the “Match field” of the processing rule set. The processing rule decision unit 71 refers to the terminal management unit 73 to search for the switch port 140 correlated to the radio access scheme instructed by the RAT decision unit 112. In the “Action” of the processing rule set, the processing rule decision unit 71 sets an instruction to forward the packet to the retrieved switch port 140.

The processing rule decision unit 71 saves the processing rule set, thus decided on, in a management DB 72. The processing rule decision unit 71 also notifies the virtual switch 14 about the processing rule set, thus decided on, via a communication unit 70.

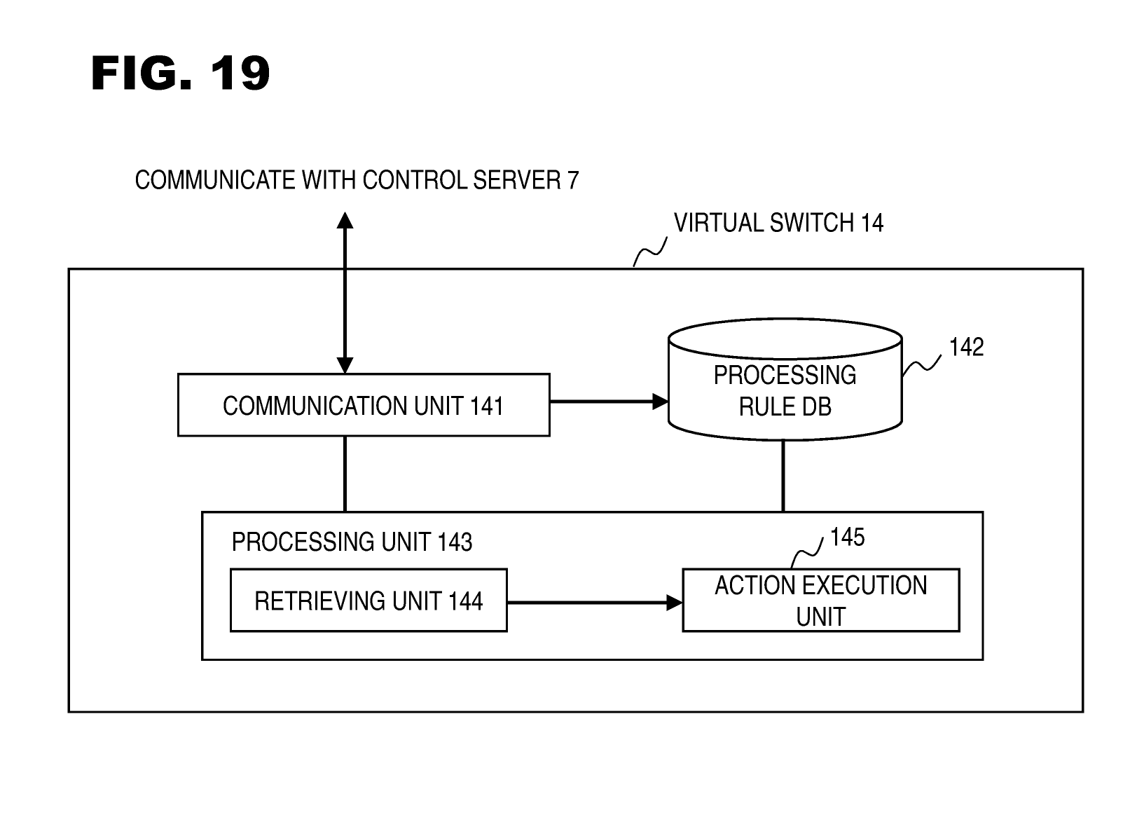

FIG. 19 shows an example configuration of the virtual switch 14.

A communication unit 141 performs communication with the control server 7 in accordance with the OpenFlow protocol.

A processing unit 143 processes a packet in accordance with the processing rule set notified from the control server 7.

A retrieving unit 144 retrieves the processing rule set, correlated to the received packet, from a processing rule DB 142. The retrieving unit 144 collates the packet against the “Matching Field” of each of the processing rule sets stored in the processing rule DB 142 to search for the processing rule set matched to the packet. An action execution unit 145 processes the packet in accordance with the processing method specified in the “Action” field of the processing rule set retrieved.

If no processing rule set matched to the received packet is present in the processing rule DB 142, the retrieving unit 144 requests the control server 7 to set the processing rule set.

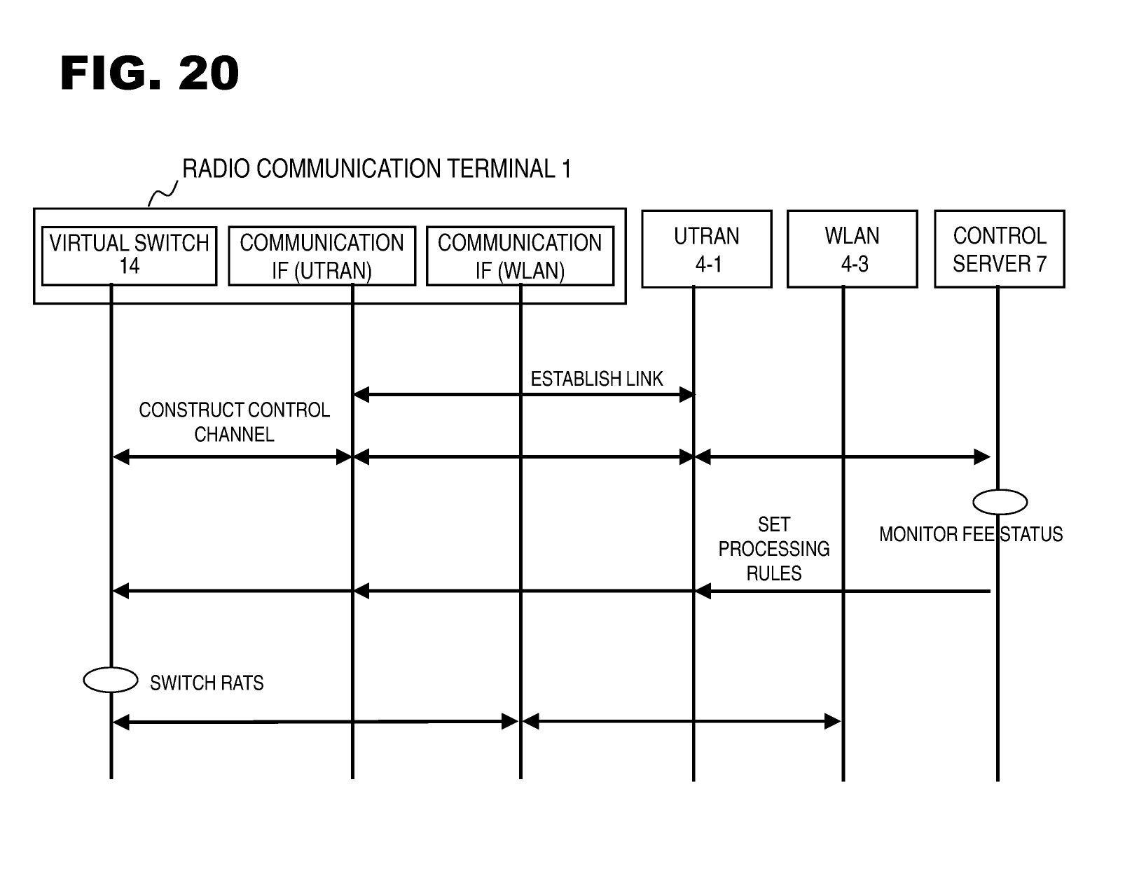

FIG. 20 depicts a sequence diagram showing an example operation of the fourth exemplary embodiment.

In establishing a link to a predetermined RAT, such as UTRAN 4-1, the radio communication terminal 1 establishes such link to the predetermined RAT, in launching its operation, for example, on power up. The radio communication terminal 1 establishes the link to the predetermined RAT by a corresponding communication interface 10. The predetermined RAT is a communication channel of a communication operator who has entered into a contract with the radio communication terminal 1.

The radio communication terminal 1 sets a control channel between it and the control server 7 via the RAT the radio communication terminal has established the link to. The radio communication terminal 1 performs communication with the control server 7 over the control channel, which control channel is the secure channel 701 of the OpenFlow technique described above.

The control server 7 monitors the communication fee of the radio communication terminal 1. The control server 7 decides the processing rule set based upon the status of the communication fee and notifies the radio communication terminal 1 about the processing rule set thus decided on. The processing rule set is set in the virtual switch 14 of the radio communication terminal 1. The virtual switch 14 switches the radio access scheme (RAT) in accordance with the so set processing rule set.

### Fifth Exemplary Embodiment

A fifth exemplary embodiment shows an example of exploiting ANDSF (Access Network Discovery and Selection Function). ANDSF is a technology the standardization of which is now ongoing in 3GPP (3rd Generation Partnership Project). It is a technology aimed to notify a terminal about the information to select the radio access scheme (RAT). In the fifth exemplary embodiment, the function to notify the terminal about the information to select the radio access scheme is adapted for use in the present invention.

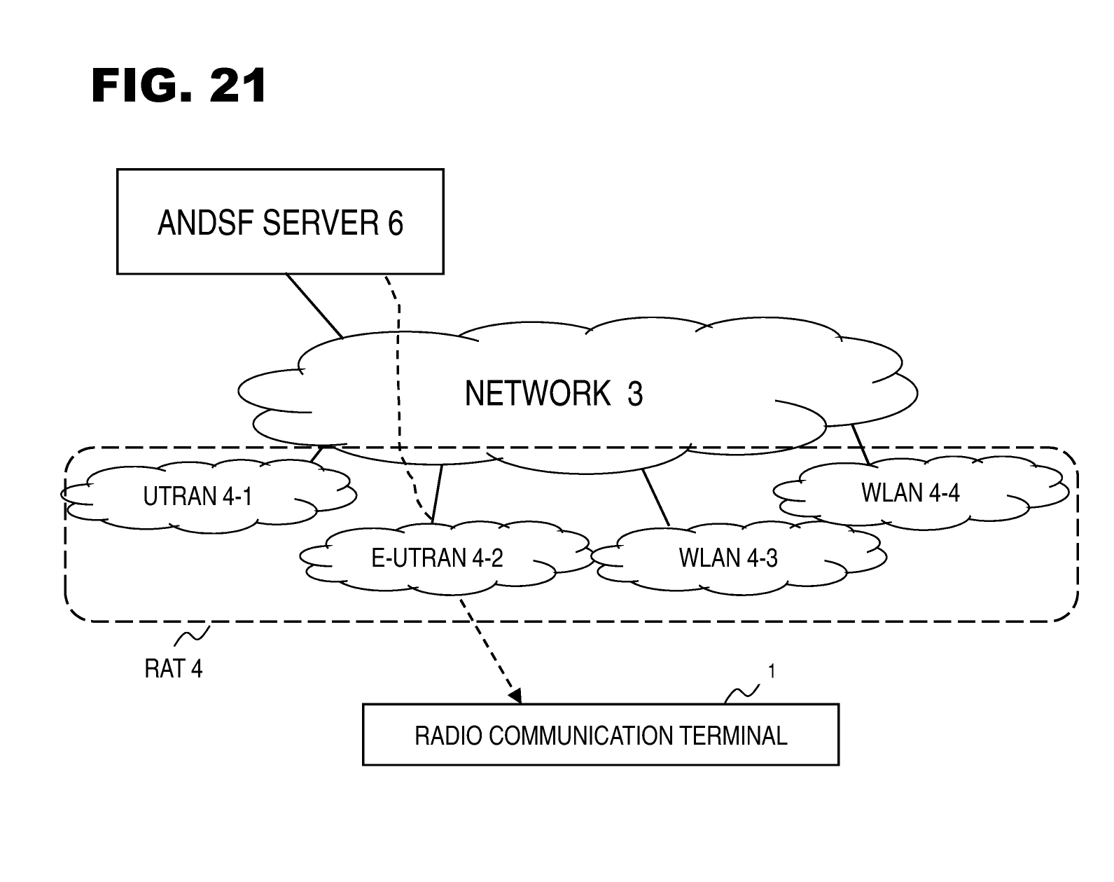

FIG. 21 shows an example system configuration of the fifth exemplary embodiment. It should be noted that the fifth exemplary embodiment may apply to any of the exemplary embodiments described above.

An ANDSF server 6 decides on the radio access scheme as used by the radio communication terminal 1, based upon the communication fee, to notify the radio communication terminal 1 about the radio access scheme thus decided on.

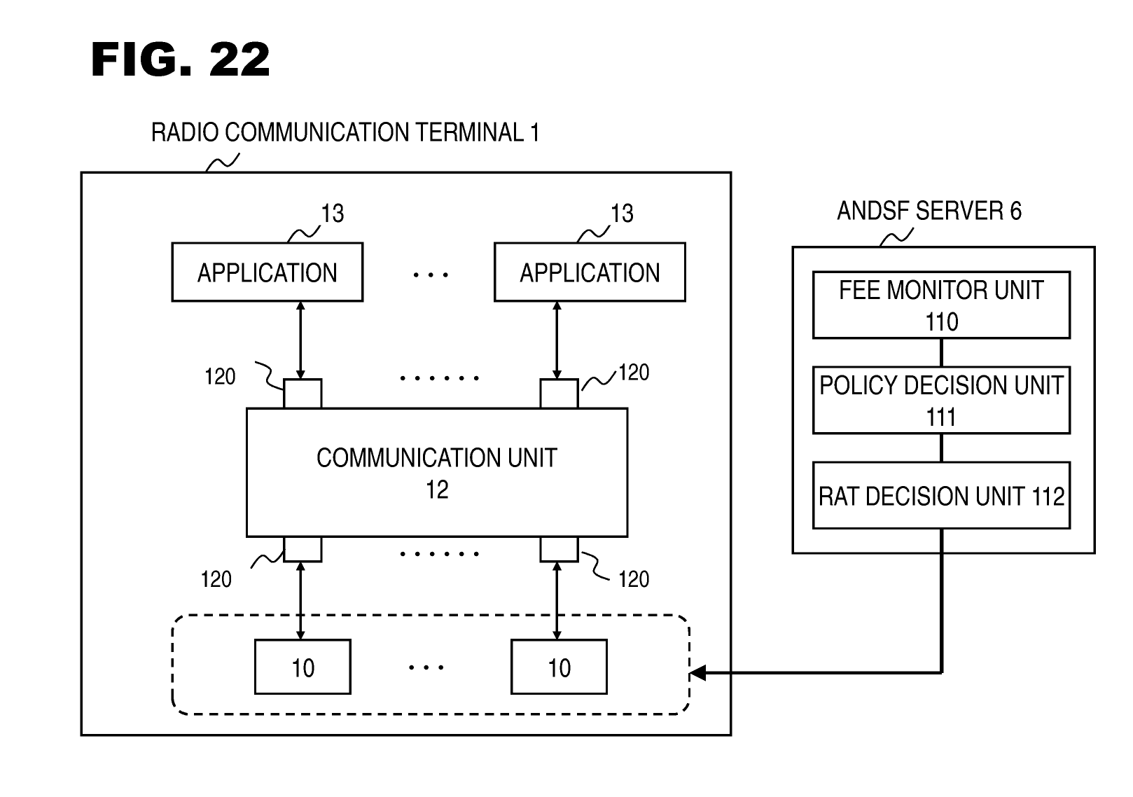

FIG. 22 shows an example configuration of the ANDSF server 6.

The ANDSF server 6 includes a fee monitor unit 110, a policy decision unit 111 and a RAT decision unit 112, these units having the functions like the corresponding units in the above described exemplary embodiments.

The fee monitor unit 110 manages the communication fee due to the radio communication terminal 1, and acquires the communication fee due to the radio communication terminal 1 from a communication operator, as an example. The fee monitor unit 110 acquires the communication fee from the communication operator, as an example, at a predetermined period. The fee monitor unit 110 may acquire the communication fee from the communication operator at an optional timing.

The ANDSF server 6 may manage the communication operator, in which case the fee monitor unit 110 does not have to get the communication fee from another entity.

The policy decision unit 111 and the RAT decision unit 112 may select the radio access scheme used by the radio communication terminal 1 by a method similar to that used in the above described exemplary embodiments, as an example, and notify the radio communication terminal 1 about the so selected radio access scheme.

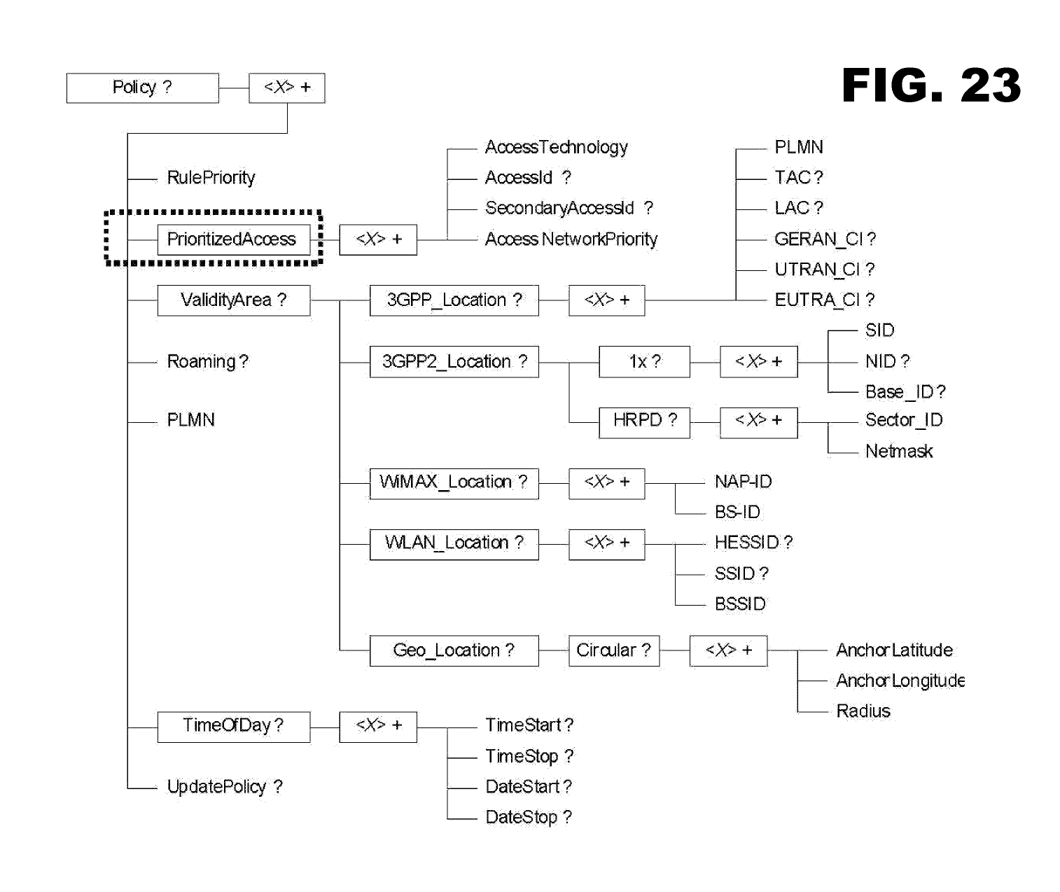

The ANDSF server 6 may inform the radio communication terminal 1 about the information by a management object (Management Object (MO)) shown as an example in FIG. 23. The management object is constructed by a tree-like structure, as shown in FIG. 23. The structure of the management object is specified in a standard specification (3GPP TS24.312, Non-Patent Literature 1). The radio communication terminal 1 refers to parameters specified in the structure to select the RAT. FIG. 23 shows a part of the parameters of the management object used in selecting the radio access scheme.

In FIG. 23, a parameter “PrioritizedAccess” is shown surrounded by a dotted line rectangle. “PrioritizedAccess” is a list of radio access schemes to be selected by the radio communication terminal 1. “PrioritizedAccess” lists a plurality of radio access scheme candidates arrayed in the order of the priority level values as decided by the ANDSF server 6.

The policy decision unit 111 and the RAT decision unit 112 save the radio access scheme, decided by the method of the above described exemplary embodiment, in “PrioritizedAccess,” and inform the radio communication terminal 1 about that effect. The policy decision unit 111 and the RAT decision unit 112 donate the values of the priority level to each of the multiple radio access schemes to save the systems in “PrioritizedAccess.”

The RAT decision unit 112 informs the communication unit 12 of the radio communication terminal 1 about the management object that has saved on board the information pertinent to the radio access scheme as selected by having reference to the communication fee.

The ANDSF server 6 may use another parameter of the standard specification in order to inform the radio communication terminal 1 about the list of the radio access schemes now carrying different priority level values. For example, the ANDSF server 6 uses “ISRP” of the management object, which “ISRP” includes parameters “ForFlowBased,” “ForServiceBased” and “ForNonSeamlessOffload.” Each of “ForFlowBased,” “ForServiceBased” and “ForNonSeamlessOffload” includes a parameter “RoutingRule,” which “RoutingRule” includes a parameter concerning the radio access scheme. The ANDSF server 6 may use the parameter for the radio access scheme, included in “RoutingRule,” to notify the radio communication terminal 1 about the priority level value of the radio access scheme.

The communication unit 12 of the radio communication terminal 1 prepares a table, such as one shown in FIG. 9 or FIG. 18, based upon the management object notified. The communication unit 12 manages the relationship of correspondence between the applications 13 and the radio access schemes, as decided on by the ANDSF server 6, based upon the table prepared. The communication unit 12 forwards the packet based upon the table prepared. Hence, the communication unit may now perform communication using the radio access scheme as decided on by the ANDSF server 6.

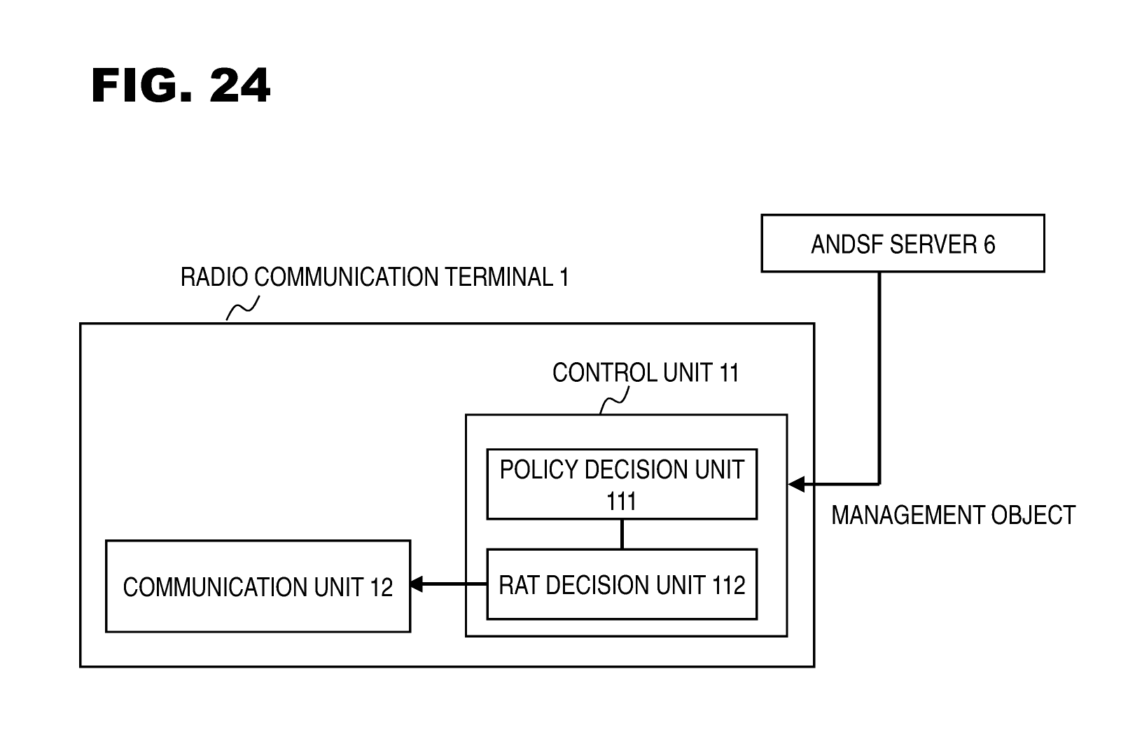

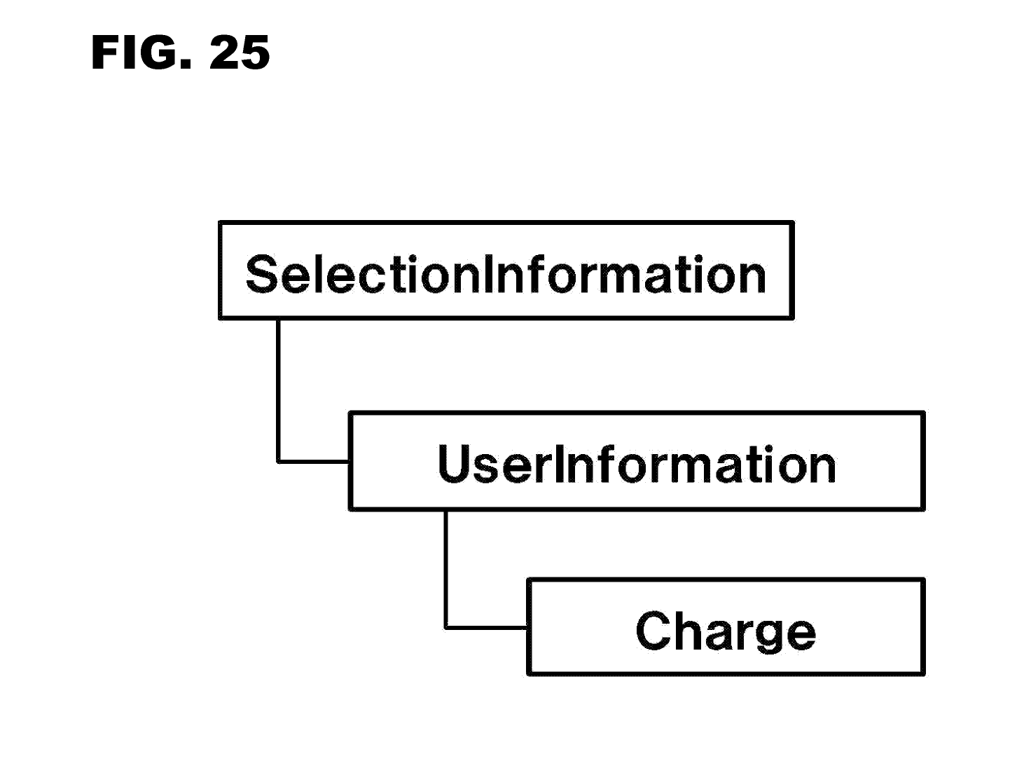

An example in which the ANDSF server 6 decides on the radio access scheme as used by the radio communication terminal 1 has been shown and described in FIG. 22 and FIG. 23. In an example shown in FIG. 24 and FIG. 25, the radio communication terminal 1 selects the radio access scheme based upon the information delivered from the ANDSF server 6.

As shown for example in FIG. 24, the control unit 11 of the radio communication terminal 1 selects the radio access scheme, as used by the application 13, based upon the management object delivered from the ANDSF server 6.

In the example shown in FIG. 23, the radio communication terminal 1 selects the RAT, using the parameter (“PrioritizedAccess”) already specified in the standard specification. FIG. 25 shows an example in which a new parameter is added to the management object specified in the standard specification.

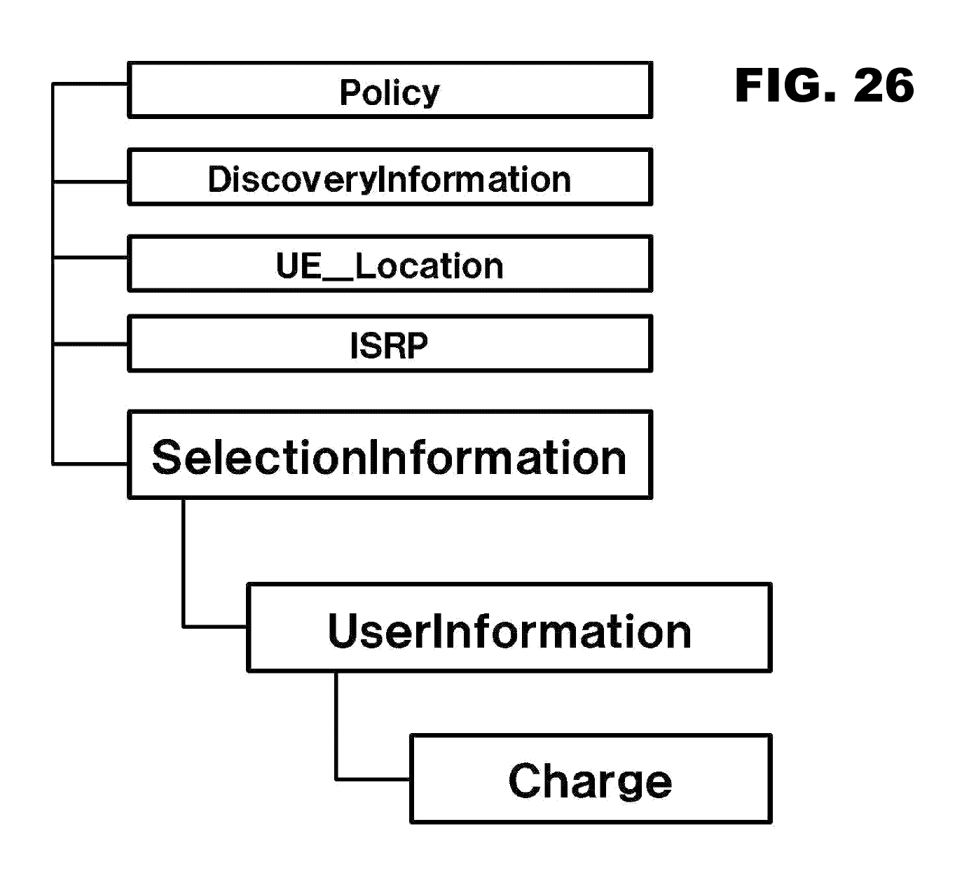

The management object of FIG. 25 includes a new parameter “SelectionInformation” that is to be used by the radio communication terminal 1 in selecting the RAT. “SelectionInformation” is added to an optional area in the management object. For example, “SelectionInformation” is set in an upper most layer of the tree structure of the management object, as indicated in an example of FIG. 26.

“SelectionInformation” is specified from one user of the radio communication terminal 1 to another, as an example. “SelectionInformation” includes a parameter “UserInformation,” as an example. “UserIformation” is the information to identify a user, as an example.

“UserIformation” includes a parameter “Charge,” as an example. In “Charge,” the communication fee of a user, conforming to the user's cumulative communication volume, as an example, is stored. The radio communication terminal 1 that has received the management object may refer to the information stored in “Charge” to comprehend the current communication fee.

The policy decision unit 111 and the RAT decision unit 112 may decide the radio access scheme, the radio communication terminal 1 uses, by a method similar to that indicated in the above described exemplary embodiments.

### Sixth Exemplary Embodiment

In a sixth exemplary embodiment, the radio communication terminal 1 seeks consent from a user in changing from one radio access scheme to another.

As the case may be, a user may desire using the radio access scheme, for which the communication fee is charged, in favor of communication stability as well as security, even though the communication fee is increased. Presumably, such user is unwilling to accept forced change of the radio access scheme. Given that the consent on the part of the user has been obtained at the time of switching between the different radio access schemes, it is possible to control the communication fee as the user's intent is taken into account.

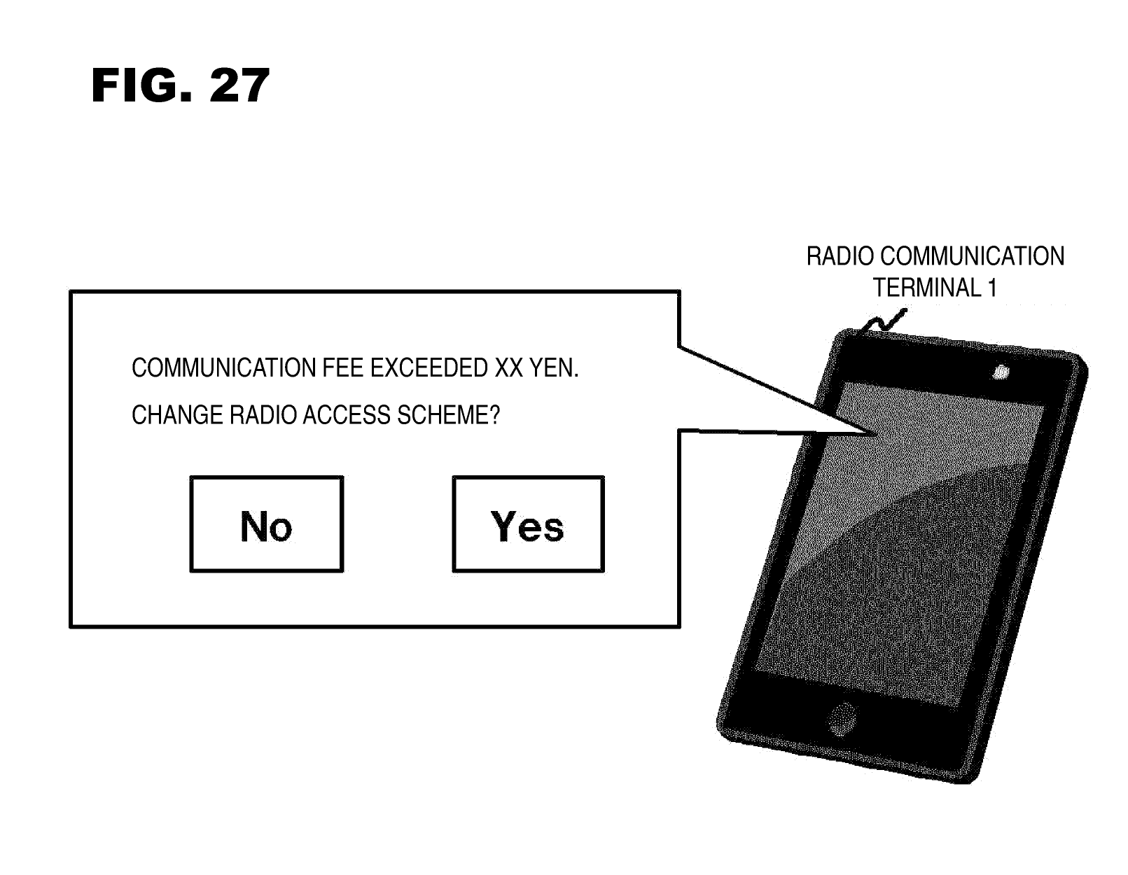

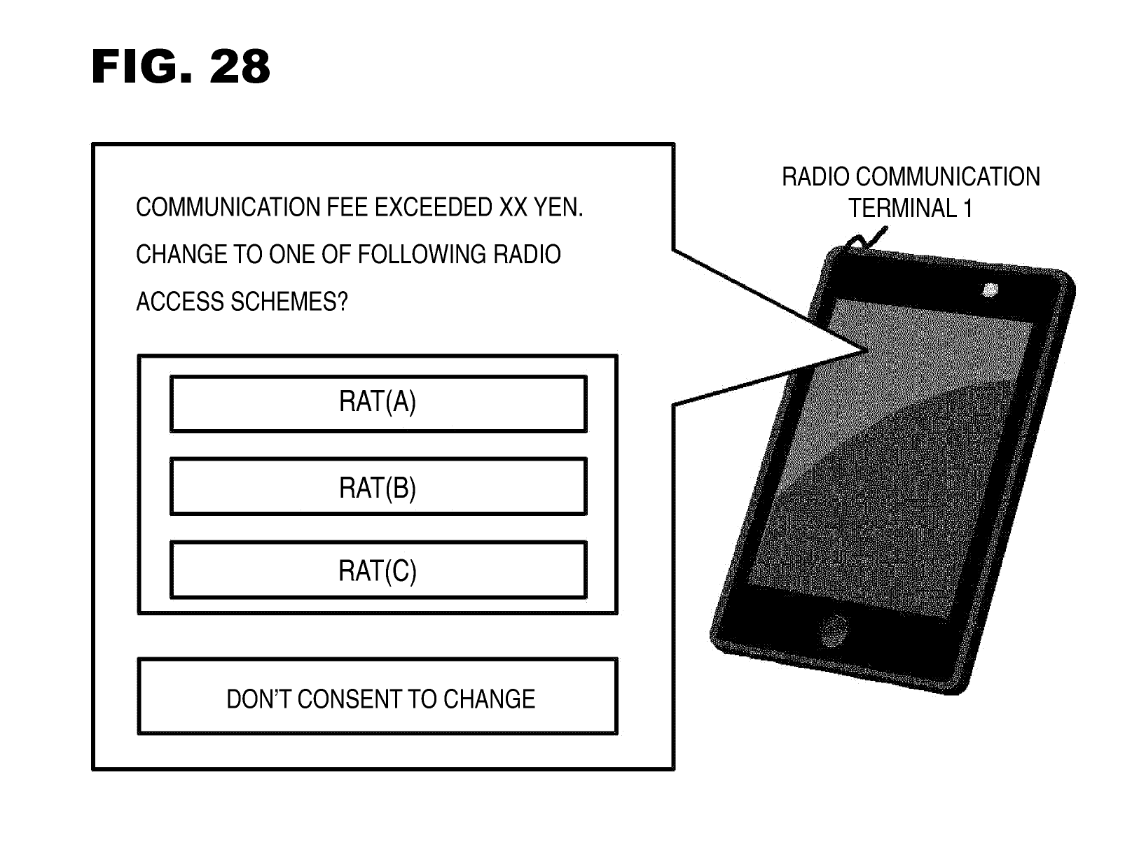

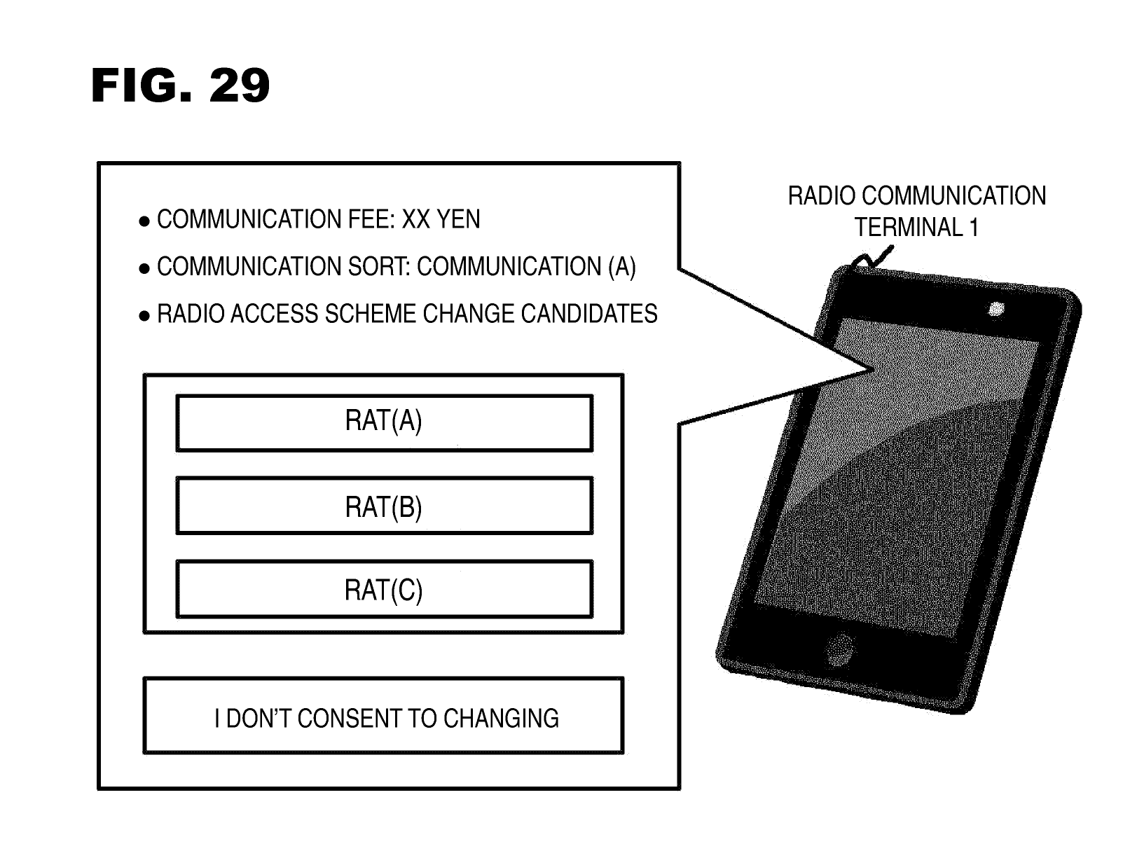

FIG. 27, FIG. 28, and FIG. 29 show different example operations of the sixth exemplary embodiment.

In switching between the different radio access schemes, depending on the communication fee, the control unit 11 of the radio communication terminal 1 displays a dialog, which seeks a user's consent, on a monitor of the radio communication terminal 1.

As shown in FIG. 27, the control unit 11 displays, on the monitor, the current communication fee and a dialog inquiring whether or not the radio access scheme is to be switched, as an example. If the user should consent to the switching, the control unit 11 instructs the communication unit 12 to switch the radio access scheme.

Also, as shown in FIG. 28, the control unit 11 of the radio communication terminal 1 may display the current communication fee and a plurality of radio access scheme candidates on the monitor, as an example. If the user should consent to the radio access scheme switching, he/she selects one of the displayed candidates. The control unit 11 instructs the communication unit 12 to switch to the radio access scheme as selected by the user.

The control unit 11 of the radio communication terminal 1 may also display on the monitor the current communication fee and a dialog which a user may select when he/she is unwilling to consent to the radio access scheme switching. In case the user is unwilling to consent to the switching, the control unit 11 discontinues the radio access scheme switching.

As shown in FIG. 29, the control unit 11 of the radio communication terminal 1 may display on the monitor a plurality of radio access scheme candidates, in keeping with the communication sorts, as an example. In the example of FIG. 29, the control unit 11 displays the current communication fee, the communication sort the user is about to begin using, such as movie streaming, and the radio access scheme candidates, on the monitor. The control unit 11 may also display a dialog the user is to select in case he/she is unwilling to consent to the radio access scheme switching.

### Seventh Exemplary Embodiment

In a seventh exemplary embodiment, in case the communication interface correlated to the radio access scheme as selected in keeping with the communication fee is in a state of standstill, the radio communication terminal boots such communication interface.

The larger the number of the communication interfaces booted, the more is the power consumed by the radio communication terminal 1. Hence, a user of the radio communication terminal 1 may be halting a part of the communication interfaces, such as communication interface for WLAN. In the seventh exemplary embodiment, the communication interface correlated to the radio access scheme as selected in keeping with the communication fee is automatically booted. It is thus possible to efficiently suppress the communication volume specific communication fee as the power consumption of the radio communication terminal 1 is suppressed.

The seventh exemplary embodiment may apply to any of the exemplary embodiments described above.

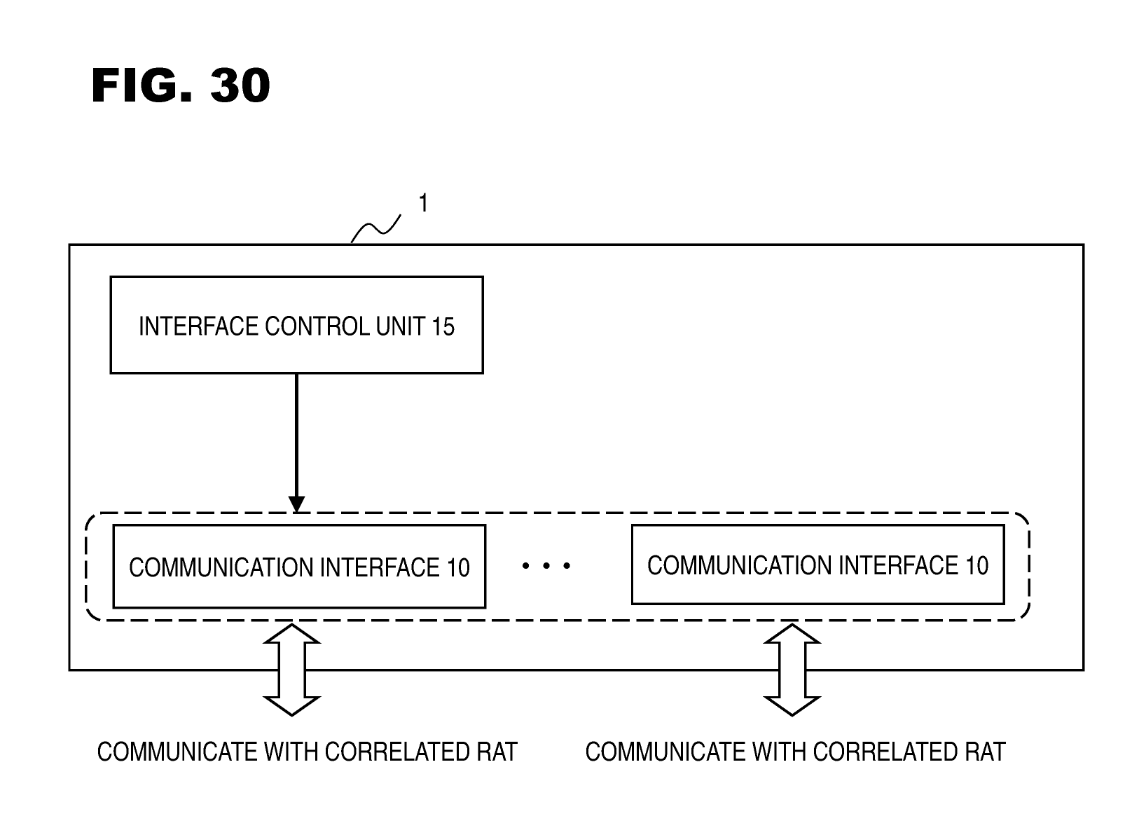

FIG. 30 shows an example configuration of the radio communication terminal 1 of the seventh exemplary embodiment.

The radio communication terminal 1 includes an interface control unit 15 in addition to the components of the example configuration of the above described exemplary embodiments.

In case the communication interface 10, as selected in keeping with the communication fee, is in a state of standstill, the interface control unit 15 boots such communication interface. The interface control unit 15 changes operation setting from “off” or “invalid” to “on” or “valid” to boot the communication interface 10. The communication interface 10, whose operation setting is “off,” is in a state of halting its predetermined function(s), such as the function to monitor the state of electrical waves. When the operation setting is changed to “on,” the communication interface 10 is enabled to perform communication with the RAT.

When booting the communication interface 10, as selected in keeping with the communication fee, the interface control unit 15 may halt the operation of the interface(s) not in use. Doing so may further decrease the power consumption by the radio communication terminal 1.

### Eighth Exemplary Embodiment

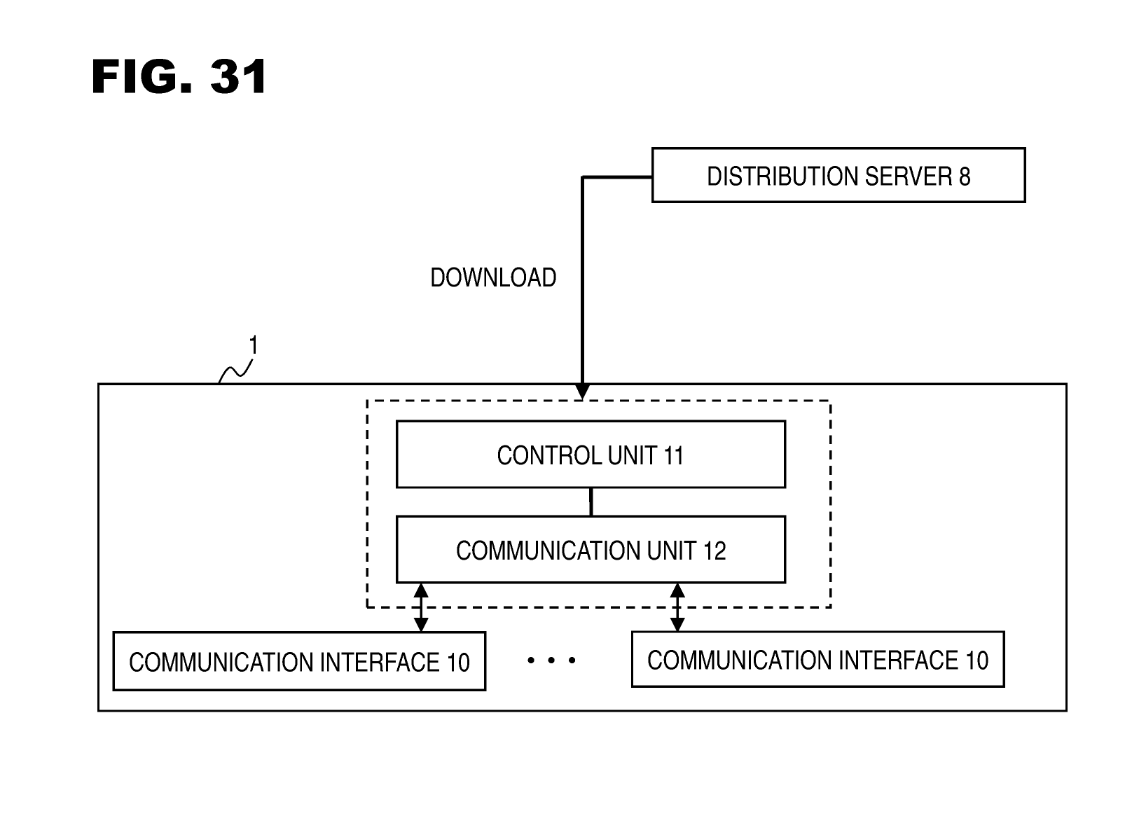

In an eighth exemplary embodiment, the radio communication terminal 1 downloads an application, having functions corresponding to those of the control unit 11 and the communication unit 12, from a distribution server 8. FIG. 31 illustrates an example of a configuration of the communication system according to the present exemplary embodiment.

In the eighth exemplary embodiment, a user of the radio communication terminal 1 is able to download an application to exploit the present invention even in case the radio communication terminal 1 lacks in the functions proper to the control unit 11 and to the communication unit 12.

The entire disclosures of the above Patent Literatures and Non-Patent Literature are incorporated herein by reference thereto. Modifications and adjustments of the exemplary embodiment are possible within the scope of the overall disclosure (including the claims) of the present invention and based on the basic technical concept of the present invention. Various combinations and selections of various disclosed elements (including each element of each claim, each element of each exemplary embodiment, each element of each drawing, etc.) are possible within the scope of the claims of the present invention. That is, the present invention of course includes various variations and modifications that could be made by those skilled in the art according to the overall disclosure including the claims and the technical concept. Particularly, any numerical range disclosed herein should be interpreted that any intermediate values or subranges falling within the disclosed range are also concretely disclosed even without specific recital thereof.

### REFERENCE SIGNS LIST

1 radio communication terminal
10 communication interface
11 control unit
110 fee monitor unit
111 policy decision unit
112 RAT decision unit
12 communication unit
120 switch port
13 application
14 virtual switch
140 switch port
141 communication unit
142 processing rule DB
143 processing unit
144 retrieving unit
145 action execution unit
15 interface control unit
3 network
4 RAT
4-1 UTRAN
4-2 E-UTRAN
4-3, 4-4 WLAN
40, 40-1, 40-2, 40-3, 40-4 base station
5 policy control server
6 ANDSF server
7 control server
70 communication unit
71 processing rule decision unit
72 management DB
73 terminal management unit
8 distribution server
600 OpenFlow switch
601 flow table
700 OpenFlow controller
701 secure channel

What is claimed is:

1. A mobile terminal, comprising:
a plurality of communication interfaces that are respectively correlated to at least one of a plurality of radio access schemes; and
a communication unit that communicates using at least one of the plurality of communication interfaces, wherein
the communication unit communicates using a communication interface correlated to a radio access scheme selected based upon a communication fee corresponding to a communication volume and upon a sort of an application used for communication.

2. The mobile terminal according to claim 1, wherein
the communication unit confirms whether or not use of the radio access scheme as selected based upon the communication fee corresponding to the communication volume and upon the sort of the application used for communication is possible to determine whether or not communication by the application is possible.

3. The mobile terminal according to claim 1, wherein
the communication unit limits communication correlated to the application if use of the selected radio access scheme is not possible.

4. The mobile terminal according to claim 1, wherein
the communication unit decides whether or not to limit communication correlated to the application based upon a priority level for the application if use of the selected radio access scheme is not possible.

5. The mobile terminal according to claim 1, wherein
the communication unit uses a usable radio access scheme for communication correlated to an application whose priority level is set to not less than a predetermined reference level if use of the selected radio access scheme is not possible.

6. The mobile terminal according to claim 1, wherein
the communication unit limits communication correlated to an application operating in a background if use of the selected radio access scheme is not possible.

7. The mobile terminal according to claim 1, wherein
the communication unit limits use of a predetermined radio access scheme in response to the communication fee exceeding a predetermined threshold value.

8. The mobile terminal according to claim 1, wherein
the communication unit limits a radio access scheme used in communication correlated to a predetermined application in response to the communication fee exceeding a predetermined threshold value.

9. The mobile terminal according to claim 1, wherein
the communication unit changes setting so that use of a communication interface correlated to the selected radio access scheme is possible.

10. The mobile terminal according to claim 1, wherein
the communication unit confirms whether or not use of a radio access scheme selected based upon policy information as set by a control apparatus that manages the radio access scheme used by the mobile terminal is possible.

11. The mobile terminal according to claim 1, wherein
the communication unit requests policy information to select a radio access scheme from a control apparatus that manages the radio access scheme used by the mobile terminal if communication of a new sort occurs.

12. The mobile terminal according to claim 1, wherein
the communication unit communicates using a communication interface correlated to the selected radio access scheme upon receiving consent from a user of the mobile terminal.

13. A communication method for a mobile terminal including a plurality of communication interfaces that are respectively correlated to at least one of a plurality of radio access schemes, the communication method comprising:
by the mobile terminal, communicating using at least one of the plurality of communication interfaces; and
communicating using a communication interface correlated to a radio access scheme selected based upon a communication fee corresponding to a communication volume and upon a sort of an application used for communication.

14. The communication method according to claim 13, wherein
the mobile terminal confirms whether or not use of the radio access scheme as selected based upon the communication fee corresponding to the communication volume and upon the sort of the application used for communication is possible to determine whether or not communication by the application is possible.

15. The communication method according to claim 13, wherein
the mobile terminal limits communication correlated to the application if use of the selected radio access scheme is not possible.

16. The communication method according to claim 13, wherein
the mobile terminal decides whether or not to limit communication correlated to the application based upon a priority level for the application if use of the selected radio access scheme is not possible.

17. The communication method according to claim 13, wherein
the mobile terminal uses a usable radio access scheme for communication correlated to an application whose priority level is set to not less than a predetermined reference level if the selected radio access scheme is not possible.

18. The communication method according to claim 13, wherein
the mobile terminal limits communication correlated to an application operating in a background if use of the selected radio access scheme is not possible.

19. The communication method according to claim 13, wherein
the mobile terminal limits use of a predetermined radio access scheme in response to the communication fee exceeding a predetermined threshold value.

20. The communication method according to claim 13, wherein
the mobile terminal limits a radio access scheme used in communication correlated to a predetermined application in response to the communication fee exceeding a predetermined threshold value.

21. The communication method according to claim 13, wherein
the mobile terminal changes setting so that use of a communication interface correlated to the selected radio access scheme is possible.

22. The communication method according to claim 13, wherein
the mobile terminal confirms whether or not use of a radio access scheme selected based upon policy information as set by a control apparatus that manages the radio access scheme used by the mobile terminal is possible.

23. The communication method according to claim 13, wherein
the mobile terminal requests policy information to select a radio access scheme from a control apparatus that manages the radio access scheme used by the mobile terminal if communication of a new sort occurs.

24. The communication method according to claim 13, wherein
the mobile terminal communicates using a communication interface correlated to the selected radio access scheme upon receiving consent from a user of the mobile terminal.

25. A communication system, comprising:
a mobile terminal; and
a base station correlated to at least one of a plurality of radio access schemes, wherein the mobile terminal comprises:
a plurality of communication interfaces that are respectively correlated to at least one of the plurality of radio access schemes; and
a communication unit that communicates using at least one of the plurality of communication interfaces, and
the communication unit communicates using a communication interface correlated to a radio access scheme selected based upon a communication fee corresponding to a communication volume and upon a sort of an application used for communication.

26. A non-transitory computer-readable recording medium, storing a program that causes a mobile terminal including a plurality of communication interfaces that are respectively correlated to at least one of a plurality of radio access schemes to execute:
communicating using at least one of the plurality of communication interfaces; and
communicating using a communication interface correlated to a radio access scheme selected based upon a communication fee corresponding to a communication volume and upon a sort of an application used for communication.

27. An information processing apparatus, comprising:
a unit that manages a communication fee corresponding to a cumulative communication volume of a mobile terminal;
a unit that generates policy information to select a radio access scheme used by the mobile terminal based upon the communication fee and upon a sort of an application used for communication; and
a unit that notifies the mobile terminal of the policy information.

28. A service rendering method, comprising:
managing a communication fee corresponding to a cumulative communication volume of a mobile terminal;
generating policy information to select a radio access scheme used by the mobile terminal based upon the communication fee and upon a sort of an application used for communication; and
notifying the mobile terminal of the policy information.

29. A distribution server, comprising:
a unit that distributes a program to a mobile terminal including a plurality of communication interfaces that are respectively correlated to at least one of a plurality of radio access schemes, wherein
the program causes the mobile terminal to execute:
communicating using at least one of the plurality of communication interfaces; and
communicating by a communication interface correlated to a radio access scheme selected based upon a communication fee corresponding to a communication volume and upon a sort of an application used for communication.
